(19) United States
(12) Patent Application Publication
(10) Pub. No.: US 2009/0174372 A1
(43) Pub. Date: Jul. 9, 2009

(54) Analog Output Circuit, Data Signal Line Driving Circuit, Display, and Potential Writing Method

(76) Inventors: Kazuhiro Maeda, Kizugawa-shi Kyoto (JP); Ichiro Shiraki, Matsusaka-shi Mie (JP); Shinsaku Shimizu, Jiangsu Province (CN); Shuji Nishi, Nara-shi Nara (JP)

Correspondence Address: HARNESS, DICKEY & PIERCE, P.L.C., P.O. BOX 8910, RESTON, VA, 20195, US

(21) Appl. No.: 12/226,131

(22) PCT Filed: Feb. 13, 2007
(86) PCT No.: PCT/JP2007/052456

§ 371 Date: Oct. 9, 2008

(30) Foreign Application Priority Data
May 24, 2006 (JP) 2006-144717

(51) Int. Cl. H02J 7/00; H02J 3/00

(52) U.S. Cl. 320/166; 307/43

(57) ABSTRACT

In one embodiment of the present invention, a voltage source is disclosed including a lower output impedance is connected to a capacitive load via a switch element and a voltage source including a higher output impedance is connected to the capacitive load via a switch element. Until a potential of an output terminal attains a reference potential, a comparator keeps the switch element in an ON state so that the voltage source writes a potential onto the capacitive load. When the potential of the output terminal exceeds the reference potential, the comparator causes the switch element to be in an ON state so that the voltage source writes a potential onto the capacitive load so as to have a predetermined potential.

### TECHNICAL FIELD

The present invention relates to an analog output circuit for charging and discharging a capacitive load.

### BACKGROUND ART

A data signal line and a pixel of a liquid crystal display device are capacitive loads each of which is to be charged and discharged. A data signal line driving circuit charges and discharges each of these capacitive loads with an analog voltage corresponding to a data signal. In case where the data signal line driving circuit is a digital driver for example, a digital signal is converted into an analog signal in the data signal line driving circuit by using a power source voltage inputted from the outside, thereby generating the analog voltage. The thus generated analog signal is outputted from an analog output circuit whose driving ability is enough to charge and discharge the capacitive load.

As the first conventional art of such an analog output circuit, a circuit basically including an analog amplifier using an operational amplifier is conventionally adopted. FIG. 30 illustrates a circuit diagram of such an analog amplifier arranged as a voltage follower.

In FIG. 30, an input voltage Vin is inputted to a noninverting input terminal of an operation amplifier 351. The operation amplifier 351 has an output terminal from which an output voltage Vout is outputted. The output terminal is connected to an inverting input terminal of the operational amplifier 351 via a switch SW302. Between the inverting input terminal and GND, a total of a wiring capacitance and an input capacitance of the operational amplifier 351 exists as a capacitance Cin. Between the inverting input terminal and the input terminal via which the input voltage Vin is inputted, a capacitor Coc for compensating for an offset of the operational amplifier 351 is provided. Between the capacitor Coc and the input terminal, a switch SW301 is provided. Further, between the output terminal and a junction of the capacitor Coc and the switch SW301, a switch SW303 is provided. Note that, Coc>>Cin.

Next, FIG. 31(a) illustrates a timing chart indicative of operation timings of the switches SW301 to SW303 of the analog output circuit.

During an offset cancellation period in which the offset of the operational amplifier 351 is compensated for, the switches SW301 and SW302 are in an ON state and the switch SW303 is in an OFF state. This results in a connection relation illustrated in FIG. 31(b), so that the inverting input terminal has the same voltage as that of the output terminal, i.e., Vin+Vof. Vof is indicative of an offset voltage of the output voltage Vout. At this time, the voltage Vof is applied to the capacitor Coc.

Next, during a normal operation period of the operational amplifier 351, the switches SW301 and SW302 are in an OFF state and the switch SW303 is in an ON state. At this time, Coc>>Cin, so that a voltage of the inverting input terminal is kept at Vin+Vof and a voltage of the capacitor Coc is kept at Vof. Thus, an offset of the output voltage Vout is compensated for so as to be equal to the input voltage Vin.

Further, as the second conventional art of the analog output circuit, a circuit basically arranged as a source follower is conventionally applied. FIG. 32 illustrates an arrangement of an analog output circuit as a source follower.

In FIG. 32, an input voltage Vin is inputted to a gate of a p-channel type MOS transistor 451 via a switch SW401. Between the gate and GND, a total of a wiring capacitance and an input capacitance of the MOS transistor 451 exists as a capacitance Cin. A drain of the MOS transistor 451 is connected to GND, and a source of the MOS transistor 451 serves as an output terminal from which an output voltage Vout of the analog output circuit is outputted. Between the output terminal and an input terminal via which the input voltage Vin is inputted, a switch SW402 and a switch SW403 are serially connected so that the switch SW402 is positioned on the side of the input terminal. Between a junction of the switches SW402 and SW403 and the gate of the MOS transistor 451, a capacitor Coc for compensating for an offset of the source follower is provided. Further, there is provided a constant current source 452 for flowing a constant current toward the source of the MOS transistor 451, i.e., towards the output terminal.

Next, FIG. 33(a) illustrates a timing chart indicative of operation timings of the switches SW401 to SW403 of the analog output circuit.

During an offset cancellation period in which the offset of the source follower is compensated for, the switches SW401 and SW403 are in an ON state and the switch SW402 is in an OFF state. This results in a connection relation illustrated in FIG. 33(b). A capacitive load is connected to the output terminal of the output voltage Vout. In an initial state, the output voltage Vout is low, so that the MOS transistor 451 is in an OFF state. Thus, when the capacitive load is charged by a current from the constant current source 452 and this causes the output voltage Vout to gradually rise to exceed a threshold voltage of the MOS transistor 451, the MOS transistor 451 becomes in an ON state. Thereafter, when a gate-source voltage of the MOS transistor 451 becomes a voltage corresponding to a value of the current from the constant current source 452, the charge of the load stops, which results in a steady state.

At this time, the offset voltage Vof of the source follower is a gate-source voltage of the MOS transistor 451. The output voltage Vout is such that input voltage Vin+offset voltage Vof. Thus, the offset voltage Vof is applied to the capacitor Coc in FIG. 33(b).

Next, during a normal operation period of the source follower, the switches SW401 and SW403 are in an OFF state and the switch SW402 is in an ON state. At this time, Coc>>Cin, so that a voltage of the capacitor Coc is kept at a level of the voltage Vof, and a gate voltage of the MOS transistor 451 becomes such that Vin−Vof. Thus, a source voltage of the MOS transistor 451, i.e., the output voltage Vout becomes equal to the input voltage Vin, so that the offset is compensated for. When the capacitive load is recharged so as to have the voltage Vin, the source follower becomes in a steady state.

Further, Patent Document 1 discloses a driving circuit provided with a precharge/predischarge circuit for driving a capacitive load. The driving circuit causes an analog amplifier to charge the capacitive load during a precharge period and then causes a circuit whose current supplying ability is suppressed to charge the capacitive load during the rest period so as to have a desired voltage.

FIG. 34 illustrates an arrangement of the driving circuit of Patent Document 1.

In FIG. 34, a precharge/predischarge circuit 120 is a circuit which carries out precharge/predischarge by causing the output voltage Vout to have a voltage level sufficiently close to the voltage Vin at high speed when the voltage Vin is applied to the input terminal 101. An output circuit 100 is a circuit which can drive an output terminal 102 so as to have the voltage Vin with high voltage accuracy. The precharge/predischarge circuit 120 includes a first differential circuit 121, a first output stage 130, a second differential circuit 122, and a second output stage 140.

The first output stage 130 includes charging means 311 and a first constant current circuit 321, and the second output stage 140 includes charging means 411 and a second constant current circuit 421.

The differential circuit 121 includes a differential pair of NMOS transistors 213 and 214 whose load is a current mirror circuit made up of PMOS transistors 211 and 212. More specifically, the differential circuit 121 includes: the NMOS transistors 213 and 214 which share a source connected to one end of a constant current source 215 and whose gates are respectively connected to an input terminal 101 (Vin) and an output terminal 102 (Vout); the PMOS transistor 211 (a current output side transistor of the current mirror circuit) whose source is connected to VDD, whose gate is connected to a gate of the PMOS transistor 212, and whose drain is connected to a drain of the NMOS transistor 213; the PMOS transistor 212 (a current input side transistor of the current mirror circuit) whose source is connected to a higher voltage source VDD and whose drain and gate are connected to as to be connected to a drain of the NMOS transistor 214; and a switch 521 provided between the other end of the constant current source 215 and a lower voltage source VSS. Sizes of the differential pair of NMOS transistors 213 and 214 are equal to each other. A drain voltage of the NMOS transistor 213 is an output of the first differential circuit 121.

Further, the first output stage 130 includes, as charging means, a PMOS transistor 311 whose drain is connected to the output terminal 102, whose gate receives an output voltage of the first differential circuit 121, and whose source is connected to an higher voltage source VDD via a switch 531, and the first output stage 130 includes, as a first constant current circuit, a constant current circuit 321 whose one end is connected to the output terminal 102 and whose other end is connected to a lower voltage source VSS via the switch 532 so as to control a current flowing between the output terminal 102 and the power source VSS.

A control terminal of each of the switches 521, 531, and 532 receives an operation control signal so as to be turned ON/OFF. When the switch is OFF, a current is stopped, thereby stopping the operation. The switches may be disposed in a manner different from FIG. 34 as long as a current can be stopped. Each of the first differential circuit 121 and the first output stage 130 has a feedback-type structure but does not have a phase compensation capacitance.

The second differential circuit 122 has a polarity opposite to a polarity of the first differential circuit 121 and includes: a current mirror circuit made up of NMOS transistors 221 and 222; a differential pair of PMOS transistors 223 and 224 whose sizes are equal to each other; and a constant current circuit 225.

In the current mirror circuit, a gate and a drain of the NMOS transistor 222 are connected to each other. A voltage Vin of the input terminal 101 is inputted to a gate of the PMOS transistor 223, and a voltage Vout of the output terminal 102 is inputted to a gate of the PMOS transistor 224. Further, a drain voltage of the differential PMOS transistor 223 is an output of the second differential circuit 122.

In the second output stage 140, an NMOS transistor 411 is provided as discharging means, and a drain of the NMOS transistor 411 is connected to the output terminal 102, and an output voltage of the second differential circuit 122 is inputted to a gate of the NMOS transistor 411, and a source of the NMOS transistor 411 is connected to a lower voltage source VSS. Further, a second constant current circuit 421 is provided so as to control a current flowing between the output terminal 102 and an higher voltage source VDD.

The second differential circuit 122 and the second output stage 140 have the switches 522, 541, and 542, each of which is controlled by an operation control signal, and a current is stopped so as to stop the operation when each switch is OFF. The switches may be disposed in a manner different from FIG. 34 as long as a current can be stopped. Note that, each of the second differential circuit 122 and the second output stage 140 has a feedback structure but does not have a phase compensation capacitance.

Further, it is preferable that a threshold voltage of the PMOS transistor 311 is sufficiently close to a threshold voltage of the transistors constituting the current mirror circuit (211, 212) and a threshold voltage of the NMOS transistor 411 is sufficiently close to a threshold voltage of the transistors constituting the current mirror circuit (221, 222).

Each of FIG. 35(a) and FIG. 35(b) illustrates how the driving circuit of FIG. 34 operates.

During each odd-numbered output period, the driving circuit carries out a driving operation by a voltage not lower than an arbitrary intermediate voltage Vm and not higher than the voltage Vdd. During each even-numbered output period, the driving circuit carries out a driving operation by a voltage lower than the voltage Vm and not lower than the voltage Vss. FIG. 35(a) illustrates a method for controlling the switches of the precharge/predischarge circuit 120 and the output circuit 100 of FIG. 34. FIG. 35(b) illustrates a voltage waveform of the output voltage Vout in two output periods, under the control illustrated by FIG. 35(a), when a voltage applied to the input terminal 101 in an arbitrary odd-numbered output period is a voltage Vin1 and a voltage applied to the input terminal 101 in a subsequent even-numbered output period is a voltage Vin2.

In the driving method of FIG. 35, a precharge/predischarge period (time t0-t1) is provided at the former half of the odd-numbered output period (time t0-t2) and a precharge/predischarge period (time t2-t3) is provided at the former half of the even-numbered output period (time t2-t4). In the precharge period (time t0-t1) of the odd-numbered output period, the voltage Vout is raised, so that the switches 521, 531, and 532 are turned ON so as to operate the first differential circuit 121 and the first output stage 130, and the switches 522, 541, and 542 are turned OFF so as to stop the second differential circuit 122 and the second output stage 140. This causes the voltage Vout to be raised to around the voltage Vin1 at high speed. After the precharge period, the switches 521, 531, and 532 are turned OFF so as to stop the first differential circuit 121 and the first output stage 130. Further, the output circuit 100 boosts the voltage Vout, having been raised to around the voltage Vin1 as the precharge, into the voltage Vin1 with high voltage accuracy.

While, in the precharge/predischarge period (time t2-t3) of the even-numbered output period, the output voltage Vout is dropped, so that the switches 522, 541, and 542 are turned ON so as to operate the second differential circuit 122 and the second output stage 140, and the switches 521, 531, and 532 are turned OFF so as to stop the first differential circuit 121 and the first output stage 130. This causes the output voltage Vout to drop to around the voltage Vin2 at high speed. After the predischarge period, the switches 522, 541, and 542 are turned OFF so as to stop the second differential circuit 122 and the second output stage 140. Further, the output circuit 100 boosts the voltage Vout, having been dropped to around the voltage Vin2 as the predischarge, into the voltage Vin2 with high voltage accuracy.

Note that, the output circuit 100 is controlled so as to operate or so as not to operate in each of the precharge period and the predischarge period in accordance with circuit properties. Alternatively, it may be so arranged that the output circuit 100 is disconnected from the input terminal 101 and the output terminal 102 instead of controlling the output circuit 100 so as not to operate.

Patent Document 1 gives the following explanations. The aforementioned driving method allows the voltage Vout in each output period to be boosted into the voltage Vin1 or the voltage Vin2 with high voltage accuracy at high speed. Further, in each of the precharge/predischarge periods, the precharge/predischarge circuit 120 operates at high speed, so that it is possible to reduce the precharge/predischarge periods. Further, the power consumption of the precharge/predischarge circuit 120 is sufficiently small, and power is consumed only in the precharge/predischarge periods.

While, according to the explanations of Patent Document 1, the output circuit 100 has only to boost the voltage, having been boosted to around the voltage Vin (Vin1, Vin2) in each of the precharge/predischarge periods, into the voltage Vin (Vin1, Vin2) after the precharge/predischarge periods with high voltage accuracy at high speed, so that a high current supplying ability is not required. Thus, a driving circuit which less consumes power can be used for the output circuit 100.

Further, Patent Document 2 discloses an analog output circuit using a comparator.

FIG. 36 illustrates an analog buffer serving as an analog output circuit.

The analog buffer of FIG. 36 includes a comparator 400 and a driving TFT410 for driving a load. Herein, the input voltage (Vin) is applied to a negative input terminal (−) of the comparator 400, and a drain terminal of the driving TFT410 is connected to a positive input terminal (+) of the comparator 400, and a gate terminal of the driving TFT410 is connected to an output terminal of the comparator 400. The driving TFT410 is a PMOS transistor, and a load is connected to its gate terminal.

First, it is assumed that a load voltage applied to the load is 0V. On this assumption, when the input voltage (Vin) is applied to the negative input terminal (−) of the comparator 400, the comparator 400 outputs a low level voltage. Herein, the low level voltage is applied to the gate terminal of the driving TFT410 so as to be turned ON. Thus, a current is supplied to the load connected to the drain terminal of the driving TFT410, so that a load voltage (Vload) rises.

The positive input terminal (+) of the comparator 400 is connected to the drain terminal of the driving TFT410. Thus, when the load voltage rises to be equal to the input voltage (Vin) applied to the negative input terminal (−), the comparator 400 outputs a high level voltage. Herein, a high level voltage is applied to the gate terminal of the driving TFT410 so as to be turned OFF. Thus, supply of power to the load is stopped, and the load voltage (Vload) does not rise any more, so that a voltage level of the input voltage (Vin) applied to the negative input terminal (−) of the comparator 400 is kept.

FIG. 36 illustrates an example where an analog buffer has a charging function for charging the load. While, in case where the analog buffer has a discharging function for discharging the load unlike the state of FIG. 36, the driving TFT is arranged as an NMOS transistor. Herein, a source terminal of the driving TFT arranged as the NMOS transistor is connected to a ground terminal, and a drain terminal of the driving TFT is connected to a positive input terminal of the comparator. This causes the load connected to the drain terminal to be discharged.

### [Patent Document 1]

Japanese Patent No. 3700558 (Japanese Unexamined Patent Publication Tokukai 2002-55659 (Publication date: Feb. 20, 2002))

### [Patent Document 2]

Japanese Unexamined Patent Publication Tokukai 2005-333635 (Publication date: Dec. 2, 2005)

### DISCLOSURE OF INVENTION

In case of driving a display panel for a liquid crystal display device by using the first or second conventional analog output circuit, it is necessary to drive a heavy load with a large amplitude, so that it is necessary to set a current, flowing in the analog output circuit, to be relatively large. Thus, it is difficult to reduce power consumption. Further, a threshold value and its unevenness in a MOS transistor serving as a switch constituting each analog output circuit cause an offset voltage between input and output voltages (generally, the MOS transistor is produced with it integrated to a display panel, so that the MOS transistor is a TFT). Thus, the output voltage deviates from the input voltage by the offset voltage, so that this raises a problem as an error factor in an impedance conversion circuit such as the voltage follower circuit and the source follower circuit. In order to alleviate the influence of the error factor, an offset compensation function using a switched capacitor or the like is generally provided as illustrated in FIG. 30 to FIG. 33. Also in this case, such setting that Coc>>Cin is carried out, but it is difficult to completely remove the offset voltage due to influence of a parasitic capacitance of the wiring, an input capacitance of the circuit, and a similar factor.

According to the technique of Patent Document 1, the precharge/predischarge circuit 120 which is an analog amplifier carries out writing during the precharge/predischarge periods so as to raise a node potential to around a desired reference potential and then directly writes the reference potential by the output circuit 100 whose current supplying ability is suppressed, thereby removing the error factor such as the offset voltage and the like of the analog amplifier. However, such control is carried out in a time-divisional manner with predetermined time intervals such as t1-t0, t2-t1, and the like, which raises such problem that this technique is less applicable and less versatile with respect to process variation. For example, in case of applying the arrangement of Patent Document 1 to a data signal line driving circuit of a liquid crystal display device, a load of a data signal line which should be driven is arbitrarily determined depending on a panel size, a structure of pixels to be connected, liquid crystal material to be used, and a similar factor. Further, also properties of a TFT to be driven have predetermined unevenness. In this manner, the load varies depending on the structure condition and the process condition. In case of the arrangement of Patent Document 1, it is necessary to realize a circuit and a timing each of which covers entire (or partial) conditions, or it is necessary to realize a circuit and a timing each of which is optimized for each condition. The former arrangement increases the power consumption due to its excessive driving ability, and the latter arrangement increases time taken to design a circuit and to carry out trial production thereof.

The analog circuit of Patent Document 2 does not have a constant current source, so that this results in such advantage that power is less consumed than that of the aforementioned analog output circuit. However, depending on a relation of (i) a charge time (Tch) taken to charge the load via the TFT of the switch element and (ii) a response time (Tres) required in driving the switch TFT in accordance with a result of comparison between a load potential and a predetermined reference potential, a final writing potential is determined. Thus, if the relation is such that Tch≦Tres, the load is excessively charged so that the excess at least corresponds to a value indicated by Tres−Tch. If the relation is such that Tch>>Tres, it is impossible to charge the load at high speed.

Further, the operation for charging the load is extremely susceptible also to a gain of the comparator. On the assumption that gain≈amplitude (Vs) required in driving a switch/required accuracy (Vacc), if Vs=5V when gain=100V, Vacc=50 mV. In a liquid crystal display device, each voltage difference of the data signals is generally about 20 to 30 mV. Thus, a small gain does not allow for high accuracy such as Vacc=50 mV. From this view point, it is difficult to obtain sufficient accuracy.

The present invention was made in view of the foregoing problems, and an object of the present invention is to realize an analog output circuit, a data signal line driving circuit, a display, and a potential writing method, each of which allows a desired potential to be written on a capacitive load with a simple arrangement, low power consumption, high speed, and high accuracy.

In order to solve the foregoing problems, an analog output circuit, writing a predetermined potential onto a capacitive load, said analog output circuit comprising: a plurality of voltage sources whose output impedances are different from each other, one of the voltage sources which has the highest output impedance outputting the predetermined potential; switch elements which respectively correspond to the voltage sources so as to be turned ON/OFF so that each of the voltage sources is electrically connected/disconnected to/from the capacitive load; and potential monitoring means which carries out an ON/OFF control for detecting a potential of the capacitive load and determining one of the switch elements, in accordance with the detected potential of the capacitive load, so as to turn ON the switch element having been determined and so as to turn OFF other switch elements.

According to the invention, the potential monitoring means carries out the ON/OFF control so as to detect the potential of the capacitive load and causes one of the voltage sources which is selected in accordance with the detected potential to be electrically connected to the capacitive load by turning ON a switch element corresponding to the voltage source and to be electrically disconnected from the capacitive load by turning OFF other switch element corresponding to other voltage source. Thus, the potential monitoring means causes the capacitive load to be electrically connected to the voltage sources sequentially in such an order that a voltage source having a lower output impedance is more preferentially turned ON, so that the predetermined potential is written onto the capacitive load initially by a voltage source having a lower output impedance at high speed and subsequently by a voltage source having a higher output impedance.

As a result, a potential can be written onto the capacitive load to some extent in a short period by a voltage source having a lower output impedance, so that it is possible to suppress power consumption in the voltage source. Further, after writing a potential by a voltage source having a lower output impedance, a potential is written by a voltage source having a higher output impedance, so that it is possible to carry out the writing with high accuracy by causing a voltage source which has a higher output impedance and hardly generates an offset to write a potential so that the potential of the capacitive load attains the predetermined potential even if an offset occurs in an output of a voltage source having a lower output impedance. Further, the writing is carried out to some extent by the voltage source having a lower output impedance, so that it does not take so long time for the voltage source having a higher output impedance to write the potential. Further, in writing a potential, switch elements are changed so as to sequentially switch voltage sources used for the writing, so that it is easy to carry out the writing and a writing rate depends only on a writing time constant and a rate in changing the switch elements. Thus, the writing can be carried out at high speed as a whole.

In this manner, it is possible to realize an analog output circuit which can write a desired potential onto the capacitive load with a simple arrangement, low power consumption, high speed, and high accuracy.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1, showing an embodiment of the present invention, is a circuit block diagram illustrating an arrangement of an analog output circuit.

In FIG. 2, FIG. 2(a) and FIG. 2(b) are graphs each of which illustrates a property of the analog output circuit of FIG. 1.

FIG. 3 is a circuit block diagram illustrating a first specific arrangement of the analog output circuit of FIG. 1.

FIG. 4 is a circuit block diagram illustrating an arrangement of a comparative example of the analog output circuit of FIG. 3.

FIG. 5 is a graph illustrating a property of the analog output circuit illustrated in FIG. 3 and FIG. 4.

FIG. 6 is a circuit block diagram illustrating a second specific arrangement of the analog output circuit of FIG. 1.

FIG. 7 is a circuit block diagram illustrating an arrangement of a comparative example of the analog output circuit of FIG. 6.

FIG. 8 is a graph illustrating a property of each of the analog output circuits respectively illustrated in FIG. 6 and FIG. 7.

FIG. 9 is a circuit block diagram illustrating a third specific arrangement of the analog output circuit of FIG. 1.

FIG. 10 is a circuit block diagram illustrating an arrangement of a comparative example of the analog output circuit of FIG. 9.

FIG. 11 is a graph illustrating a property of each of the analog output circuits respectively illustrated in FIG. 9 and FIG. 10.

FIG. 12 is a circuit block diagram illustrating a fourth specific arrangement of the analog output circuit of FIG. 1.

FIG. 13 is a circuit block diagram illustrating an arrangement of a comparative example of the analog output circuit of FIG. 12.

FIG. 14 is a graph illustrating a property of each of the analog output circuits respectively illustrated in FIG. 12 and FIG. 13.

FIG. 15 is a circuit block diagram illustrating a fifth specific arrangement of the analog output circuit of FIG. 1.

FIG. 16 is a circuit block diagram illustrating an arrangement of a comparative example of the analog output circuit of FIG. 15.

FIG. 17 is a graph illustrating a property of each of the analog output circuits respectively illustrated in FIG. 15 and FIG. 16.

In FIG. 18, FIG. 18(a) and FIG. 18(b) are circuit diagrams each of which illustrates a comparative example of a comparator.

In FIG. 19, FIG. 19(a) and FIG. 19(b) are circuit block diagrams each of which illustrates a modification example of the analog output circuit of FIG. 1.

In FIG. 20, FIG. 20(a) and FIG. 20(b) are circuit block diagrams each of which illustrates a modification example of the analog output circuit of FIG. 1.

In FIG. 21, FIG. 21(a) and FIG. 21(b) are circuit diagrams each of which illustrates an arrangement of a voltage source applicable to FIG. 19 and FIG. 20.

FIG. 22 is a circuit block diagram illustrating a first driving method of the analog output circuit of FIG. 1.

FIG. 23 is a potential waveform diagram illustrating an operation in the arrangement of FIG. 22.

FIG. 24 is a circuit block diagram illustrating a second driving method of the analog output circuit of FIG. 1.

FIG. 25 is a potential waveform diagram illustrating an operation in the arrangement of FIG. 24.

In FIG. 26, FIG. 26(a) to FIG. 26(c) are diagrams each of which illustrates a relation between a video signal polarity and a common voltage of a liquid crystal display device.

FIG. 27, showing an embodiment of the present invention, is a block diagram illustrating an arrangement of a liquid crystal display device.

FIG. 28 is a circuit diagram illustrating an arrangement of a pixel of the liquid crystal display device of FIG. 27.

FIG. 29 is a block diagram illustrating an arrangement of a data processing circuit provided on a data signal line driving circuit of the liquid crystal display device of FIG. 27.

FIG. 30, showing a conventional technique, is a circuit diagram illustrating a first arrangement of an analog output circuit.

In FIG. 31, FIG. 31(a) to FIG. 31(c) are diagrams each of which illustrates an operation of the analog output circuit of FIG. 30.

FIG. 32, showing a conventional technique, is a circuit diagram illustrating a second arrangement of an analog output circuit.

In FIG. 33, FIG. 33(a) to FIG. 33(c) are diagrams each of which illustrates an operation of the analog output circuit of FIG. 32.

FIG. 34, showing a conventional technique, is a circuit diagram illustrating a third arrangement of an analog output circuit.

In FIG. 35, FIG. 35(a) and FIG. 35(b) are diagrams each of which illustrates an operation of the analog output circuit of FIG. 34.

FIG. 36, showing a conventional technique, is a circuit diagram illustrating a fourth arrangement of an analog output circuit.

### REFERENCE NUMERALS

1 Analog output circuit
2 Comparator (potential monitoring means)
V1, V2 Voltage source
C Capacitive load
SW1, SW2 Switch element

### BEST MODE FOR CARRYING OUT THE INVENTION

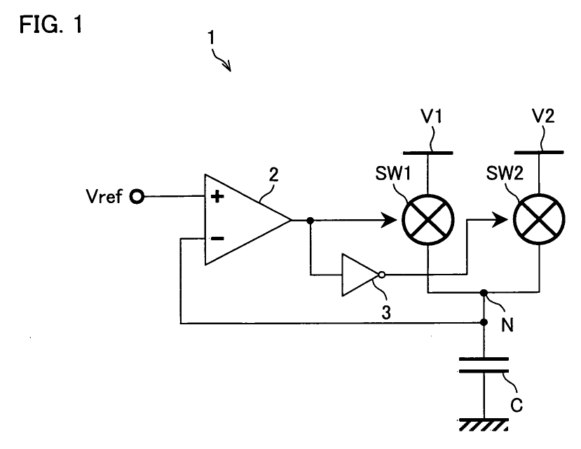

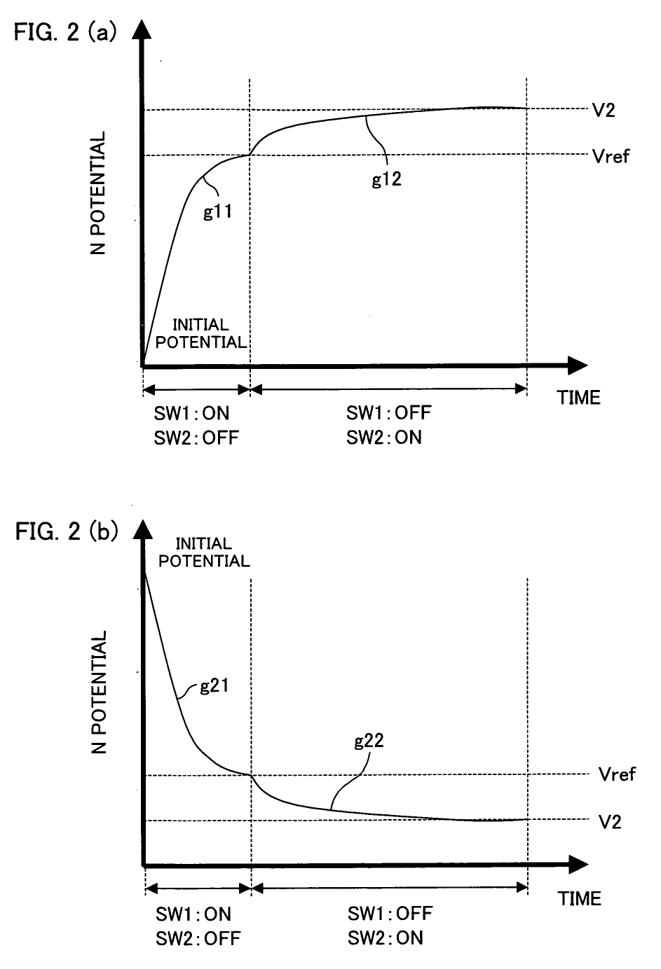

With reference to FIG. 1 to FIG. 29, the following will describe an embodiment of the present invention.

FIG. 1 illustrates an arrangement of an analog output circuit 1 according to the present embodiment. The analog output circuit 1 includes: voltage sources V1 and V2; switch elements SW1 and SW2; a comparator 2; and an inverter 3.

A capacitive load C is connected to an output terminal N of the analog output circuit 1. Each of the voltage sources V1 and V2 writes a predetermined potential onto the capacitive load by charging or discharging the capacitive load C. An output impedance of the voltage source V2 is higher than an output impedance of the voltage source V1.

The switch SW1 is a switch circuit provided between the voltage source V1 and the output terminal N so as to correspond to the voltage source V1. When the switch element SW1 is turned ON, the voltage source V1 and the capacitive load C are electrically connected to each other. When the switch element SW1 is turned OFF, the voltage source V1 and the capacitive load are electrically disconnected from each other. Further, the switch SW2 is a switch circuit provided between the voltage source V2 and the output terminal N so as to correspond to the voltage source V2. When the switch element SW2 is turned ON, the voltage source V2 and the capacitive load C are electrically connected to each other. When the switch element SW2 is turned OFF, the voltage source V2 and the capacitive load C are electrically disconnected from each other.

A reference potential Vref is inputted to a noninverting input terminal of the comparator 2, and a potential of the output terminal N, i.e., a potential of the capacitive load C is inputted to an inverting input terminal of the comparator 2. The comparator 2 compares the potential of the output terminal N with the reference potential Vref and outputs a high potential when the potential of the output terminal N is lower than the reference potential Vref and outputs a low potential when the potential of the output terminal N is higher than the reference potential Vref. The high and low potentials are an example of a logic determined with respect to a subsequent circuit and may be inverted. The output of the comparator 2 is inputted to an ON/OFF control terminal of the switch element SW1 and its logic is inverted by the inverter 3 so as to be inputted to an ON/OFF control terminal of the switch element SW2.

When the ON/OFF control terminal of each of the switch elements SW1 and SW2 receives the high potential, each of the switch elements SW1 and SW2 is turned ON. When the ON/OFF control terminal of each of the switch elements SW1 and SW2 receives the low potential, each of the switch elements SW1 and SW2 is turned OFF. Thus, when the potential of the output terminal N is lower than the reference potential Vref, the switch element SW1 is turned ON and the switch element SW2 is turned OFF. When the potential of the output terminal N is higher than the reference potential Vref, the switch element SW1 is turned OFF and the switch element 2 is turned ON. As a result, in the analog output circuit of FIG. 1, when the potential of the output terminal N is lower than the reference potential Vref, the voltage source V1 carries out writing in the capacitive load C, and when the potential of the output terminal N is higher than the reference potential Vref, the voltage source V2 carries out writing in the capacitive load C.

In this manner, the comparator 2 detects a potential of the capacitive load C and determines a switch element to be turned ON according to the detected potential of the capacitive load C so as to cause the determined switch element to be turned ON, and the comparator 2 causes other switch element to e turned OFF. The comparator 2 controls ON/OFF in this manner as potential monitoring means.

Herein, the writing can be carried out in two manners: A manner in which a potential higher than an initial potential of the capacitive load C is written onto the capacitive load C; and a manner in which a potential lower than the initial potential is written onto the capacitive load C.

FIG. 2(a) illustrates how the potential of the output terminal N varies with time passage in case of writing a potential higher than the initial potential onto the capacitive load C. In this case, when output potentials of the voltage sources V1 and V2 are indicated as V1 and V2 respectively, the setting is such that V1>Vref and V2>Vref. A potential finally written onto the capacitive load C is the potential V2. Whether V1 is higher or lower than V2 may be arbitrarily determined, but it is assumed herein that V2≧V1. Also, it is assumed that the potential of the capacitive load C rises from the lower side to the higher side in a single direction. The switch SW1 is ON and the switch SW2 is OFF until the time when the potential of the output terminal N rises from the initial potential and attains the reference potential Vref. As a result, the potential of the output terminal N rises as illustrated by a curve g11. The curve g11 is indicative of a time constant determined in accordance with the voltage source V1, the capacitive load C, and circuit resistances thereof. The switch element SW1 is OFF and the switch element SW2 ON until the time when the potential of the output terminal N rises from the reference potential Vref and attains the potential V2. As a result, the potential of the output terminal N rises as illustrated by a curve g12. The curve g12 is indicative of a time constant determined in accordance with the voltage source V2, the capacitive load C, and circuit resistances thereof.

FIG. 2(b) illustrates how the potential of the output terminal N varies with time passage in case of writing the potential lower than the initial potential in the capacitive load C. In this case, setting is such that V1<Vref and V2<Vref. A potential finally written onto the capacitive load C is the potential V2. The potentials V1 and V2 may be set so that the one is higher than the other one or may be set so that the one is lower than the other one. Herein, let us consider the case where V1≧V2 and the capacitive load C drops in a single direction from the higher side to the lower side. The switch element SW1 is ON and the switch element SW2 is OFF until the time when the potential of the output terminal N rises from the initial potential and attains the reference potential Vref, and the potential of the output terminal N drops in a manner illustrated by a curve g21. The curve g21 is indicative of a time constant determined in accordance with the voltage source V1, the capacitive load C, and circuit resistances thereof. The switch element SW1 is OFF and the switch element SW2 is ON until the time when the potential of the output terminal rises from the reference potential Vref and attains the potential V2, and the potential of the output terminal N drops in a manner illustrated by a curve g22. The curve g22 is indicative of a time constant determined in accordance with the voltage source V2, the capacitive load C, and circuit resistances thereof.

In the case of FIG. 2(a) and in the case of FIG. 2(b), the potential V2 is initially written onto the capacitive load C at high speed by the voltage source V1 having a lower output impedance, and subsequently, the writing is carried out by the voltage source V2 having a higher output impedance.

A certain potential such as the reference potential Vref is written onto the capacitive load C in a short period by the voltage source V1 having a lower output impedance, so that it is possible to suppress energy consumed in the voltage source V1. Further, the potential is written onto the capacitive load C by the voltage source V2 having a higher output impedance after writing the potential by the voltage source V1 having a lower output impedance. Thus, even in case where an output of the voltage source V1 having a lower output impedance is offset, it is possible to carry out highly accurate writing by writing the potential V2 onto the capacitive load C by the voltage source V2 which hardly causes offset and whose output impedance is large. Further, the writing is carried out to some extent by the voltage source V1 having a lower output impedance, so that it does not take so long time to carry out the writing by the voltage source V2 having a higher output impedance. Further, in the potential writing, the switch elements SW1 and SW2 are switched and the voltage source used in the writing are sequentially switched, so that it is easy to carry out the writing and the writing rate depends only on the switching rates of the switch elements SW1 and SW2 as well as the time constant at the time of the writing. Thus, it is possible to carry out the writing at high speed as a whole.

With the foregoing arrangement, it is possible to realize an analog output circuit which allows a desired potential to be written onto the capacitive load with a simple arrangement, low power consumption, high speed, and high accuracy.

The following describes some specific examples of a combination of the voltage sources V1 and V2.

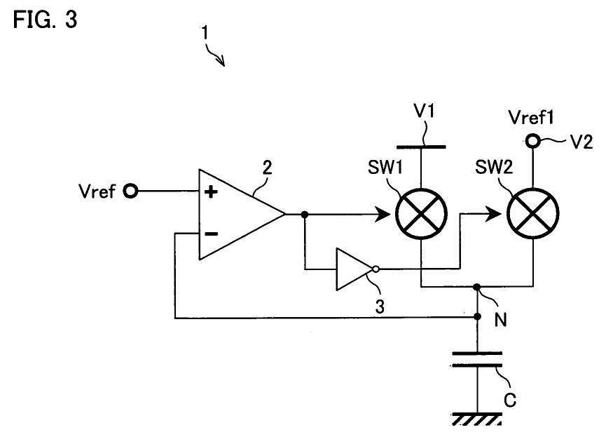

FIG. 3 illustrates a first specific example of the combination of the voltage sources V1 and V2. The voltage source V1 of FIG. 3 includes a power source line extending from a direct current stabilized power supply, and the voltage source V2 includes a voltage dividing circuit for dividing a voltage obtained from the power source line extending from the direct current stabilized power supply. An example of the voltage source V2 arranged in this manner is a reference potential generation circuit for generating a reference potential corresponding to a data signal of the liquid crystal display device. Herein, an output potential of the voltage source V2 is a potential Vref1.

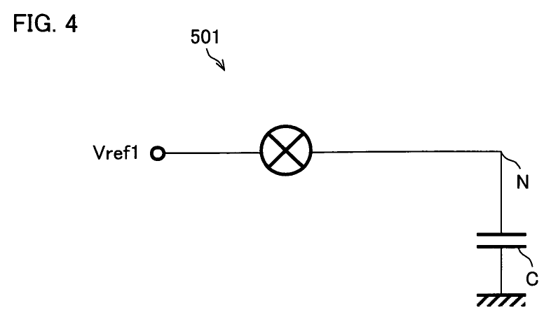

Besides, FIG. 4 illustrates an arrangement of a conventional analog output circuit in which only the voltage dividing circuit writes a potential onto the capacitive load C.

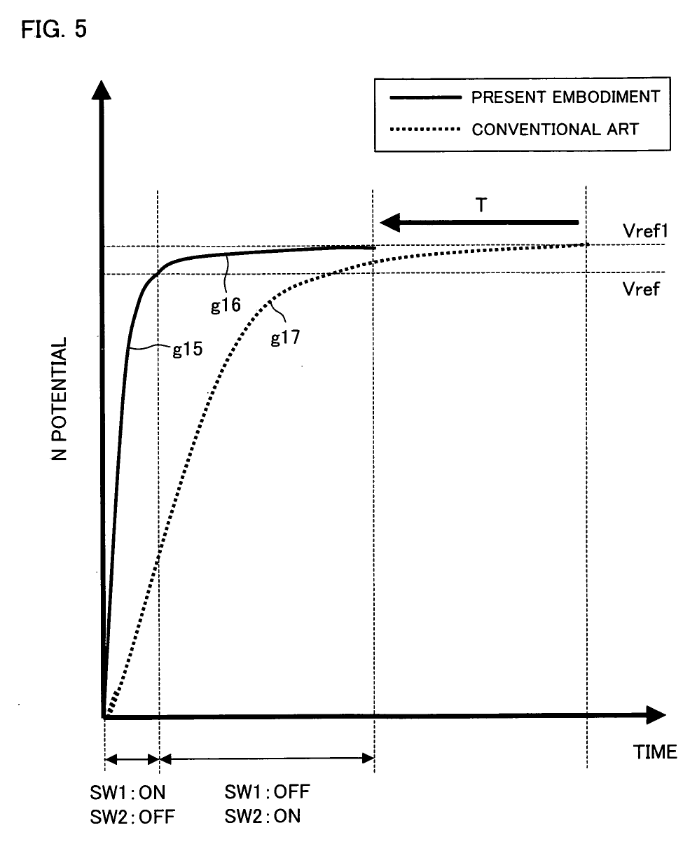

FIG. 5 illustrates how a potential of the output terminal N of the analog output circuit 1 of FIG. 3 varies with time passage and how a potential of the output terminal N of the analog output circuit 501 of FIG. 4 varies with time passage. FIG. 5 shows how a potential which is written onto the capacitive load C and is higher than an initial potential varies with time passage. As to a condition indicative of how a potential which is written onto the capacitive load C and is lower than an initial potential varies with time passage, the condition is found out by vertically inverting the graph indicated by FIG. 5. This is applicable also to the subsequent graphs.

In the analog output circuit 501 of FIG. 4, a potential varies as in a curve g17, and it takes long time for the potential of the output terminal N to attain the reference potential Vref1. In the analog output circuit 1 of FIG. 3, the writing is carried out by the voltage source V1 during a period of time taken for the potential to vary from the initial potential to the reference potential Vref as illustrated by a curve g15, and the writing is carried out by the voltage source V2 during a period of time taken for the potential to vary from the reference potential Vref to the reference potential Vref1 as illustrated by a curve g16, so that the time taken for the potential of the output terminal N to attain the reference potential Vref1 can be made shorter as shown by the time T of FIG. 3. Further, the writing carried out in the manner shown by a curve g16 with the reference potential Vref, so that the foregoing time can be made shorter and energy consumed by a current flowing in the voltage dividing circuit can be reduced. Further, appropriate adjustment of a current allows an output voltage of the voltage dividing circuit to be set to a more accurate value, so that there is no offset in an output voltage of the voltage follower circuit or the source follower circuit. As a result, the reference voltage Vref1 can be written onto the capacitive load C with high accuracy finally.

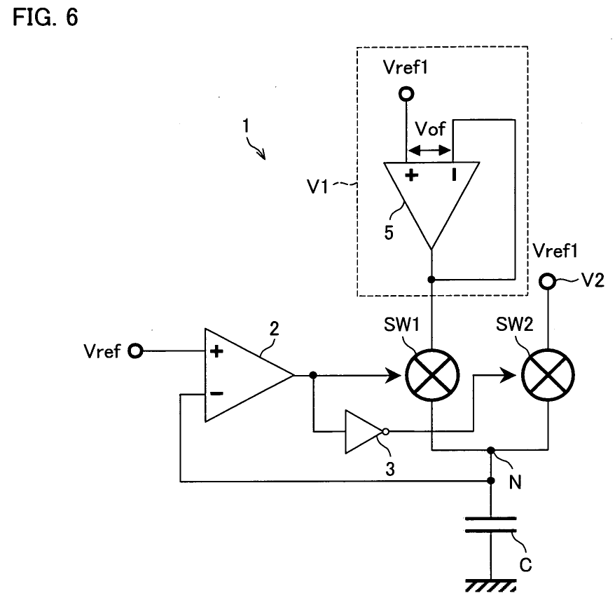

FIG. 6 illustrates a second specific example of the combination of the voltage sources V1 and V2. The voltage source V1 of FIG. 6 includes a voltage follower circuit using an operation amplifier 5, and the voltage source V2 includes the voltage dividing circuit illustrated in FIG. 3. In the voltage source V1, the reference potential Vref1 is inputted to a noninverting input terminal of the operation amplifier 5. Further, an offset voltage occurring at an output potential of the operation amplifier 5 is Vof.

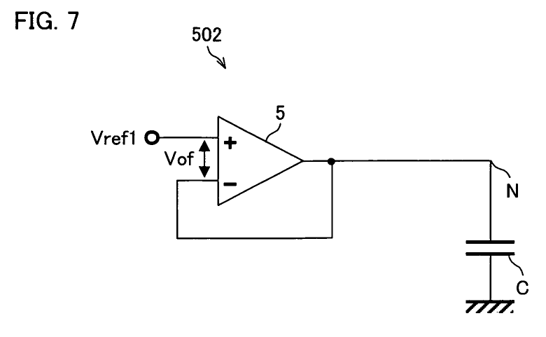

Besides, FIG. 7 illustrates an arrangement of a conventional analog output circuit 502 in which a potential is written onto the capacitive load C only by the voltage follower circuit.

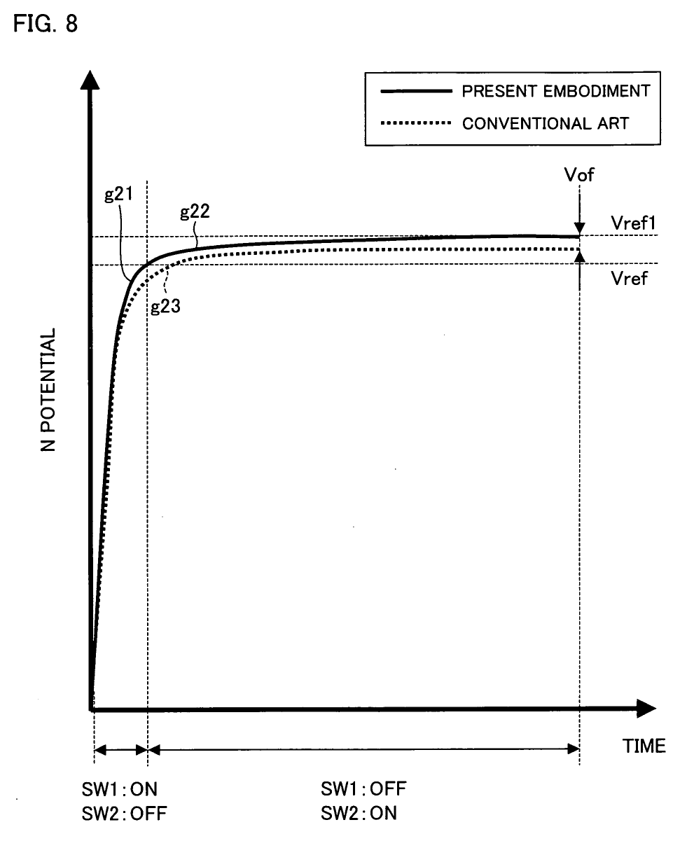

FIG. 8 illustrates how a potential of the output terminal N of the analog output circuit 1 of FIG. 6 varies with time passage and how a potential of the output terminal N of the analog output circuit 502 of FIG. 7 varies with time passage.

In the analog output circuit 502 of FIG. 7, the offset voltage Vof of the operation amplifier 5 causes the potential of the output terminal N to finally deviate from the reference potential Vref1 by the offset voltage Vof as shown by a curve g23. FIG. 8 illustrates a case where an offset occurs in a negative direction. Thus, a potential which is lower than the reference potential Vref1 by Vof is finally written. However, in case where the offset occurs in a positive direction, a potential which is higher than the reference potential Vref1 by Vof is finally written. On the other hand, in the analog output circuit 1 of FIG. 6, the writing is carried out by the voltage source V1 during a period of time taken for the potential to vary from the initial potential to the reference potential Vref as illustrated by a curve g21, and the writing is carried out by the voltage source V2 during a period of time taken for the potential to vary from the reference potential Vref to the reference potential Vref1 as illustrated by a curve g22, so that the writing is carried out with respect to the capacitive load C by the voltage source V2 finally, and the reference potential Vref1 is free of offset, which results in the reference potential Vref1 with high accuracy.

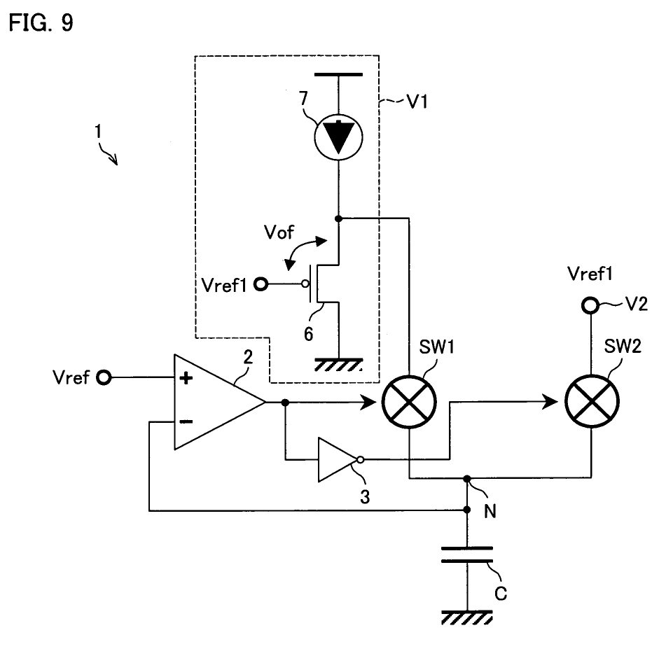

FIG. 9 illustrates a third specific example of the combination of the voltage sources V1 and V2. The voltage source V1 of FIG. 9 includes a source follower circuit using a MOS transistor 6, and the voltage source V2 includes the voltage dividing circuit illustrated in FIG. 3. The MOS transistor 6 is a p-channel type, and there is provided a constant current source 7 for flowing a constant current to a source of the MOS transistor 6. Further, the source is connected to the switch element SW1. A drain of the MOS transistor 6 is connected to GND. A gate of the MOS transistor 6 receives the reference potential Vref1. Further, an offset voltage of the source potential with respect to a gate potential is Vof.

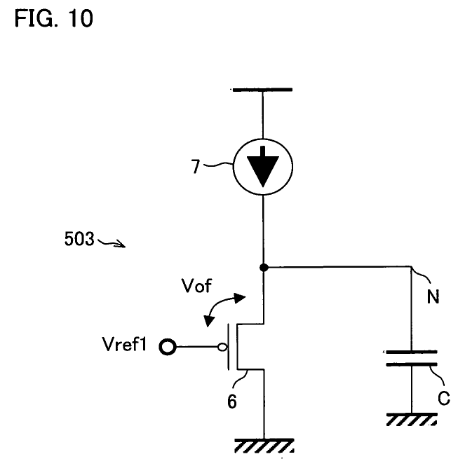

Besides, FIG. 10 illustrates an arrangement of a conventional analog output circuit 503 in which a potential is written onto the capacitive load C only by the source follower circuit.

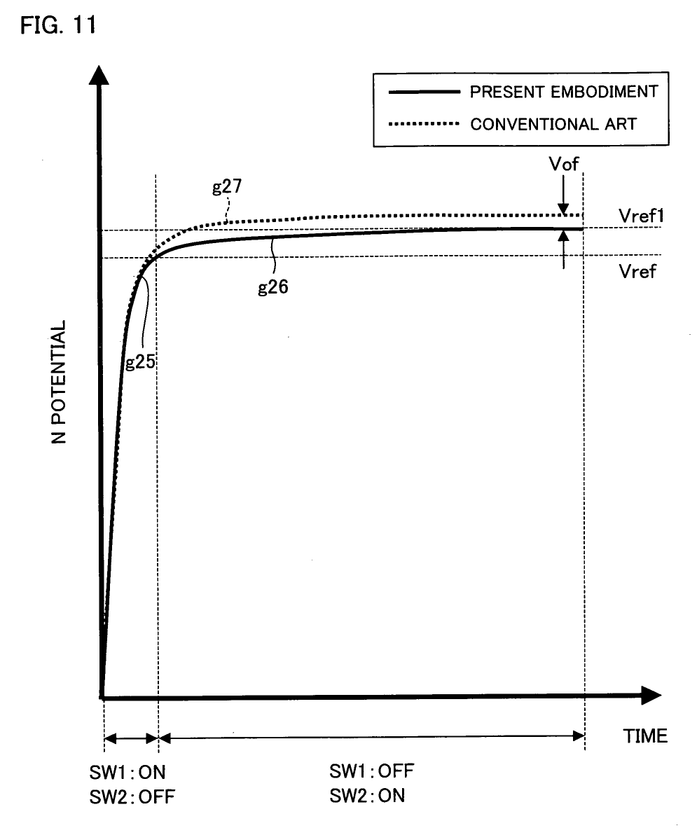

FIG. 11 illustrates how a potential of the output terminal N of the analog output circuit 1 of FIG. 9 varies with time passage and how a potential of the output terminal N of the analog output circuit 530 of FIG. 10 varies with time passage.

In the analog output circuit 503 of FIG. 10, the offset voltage Vof of the source follower circuit causes the potential of the output terminal N to finally deviate from the reference potential Vref1 by the offset voltage Vof as shown by a curve g27. FIG. 11 illustrates a case where the offset occurs in a positive direction, so that a potential which is higher than the reference potential Vref1 by Vof is finally written. However, in case where the offset occurs in a negative direction like a case where the foregoing circuit is constituted of an n-channel MOS transistor or a similar case, a potential which is lower than the reference potential Vref1 by Vof is finally written. On the other hand, in the analog output circuit 1 of FIG. 9, the writing is carried out by the voltage source V1 during a period of time taken for the potential to vary from the initial potential to the reference potential Vref as illustrated by a curve g25, and the writing is carried out by the voltage source V2 during a period of time taken for the potential to vary from the reference potential Vref to the reference potential Vref1 as illustrated by a curve g26, so that the potential is finally written onto the capacitive load C by the voltage source V2, and the reference potential Vref1 is free of offset, which results in the reference potential Vref1 with high accuracy.

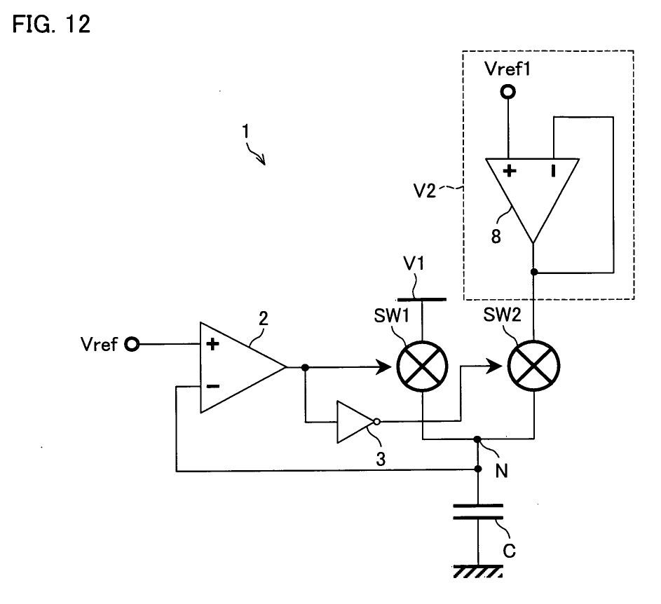

FIG. 12 illustrates a fourth specific example of the combination of the voltage sources V1 and V2. The voltage source V1 of FIG. 12 includes a power source line extended from a direct current stabilized power supply, and the voltage source V2 includes a voltage follower circuit using an operation amplifier 8. Herein, an output voltage of the operation amplifier 8 is free of any offset. The reference potential Vref1 is inputted to a noninverting input terminal of the operation amplifier 8, and an output potential of the voltage source V2 is the reference potential Vref1.

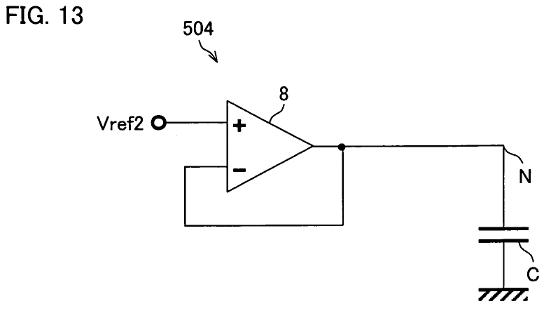

Besides, FIG. 13 illustrates an arrangement of a conventional analog output circuit 504 in which a potential is written onto the capacitive load C only by the voltage follower circuit.

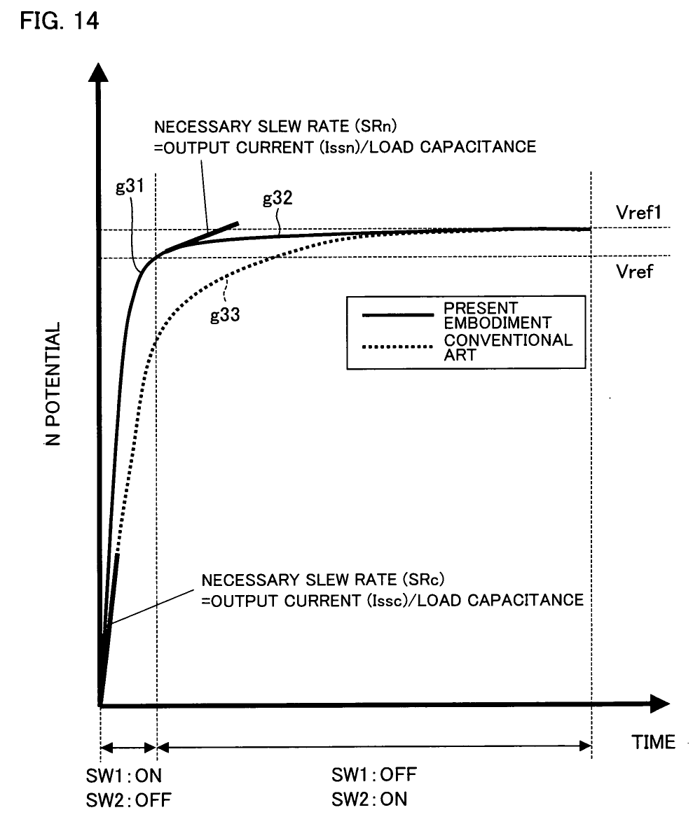

FIG. 14 illustrates how a potential of the output terminal N of the analog output circuit 1 of FIG. 12 varies with time passage and how a potential of the output terminal N of the analog output circuit 504 of FIG. 13 varies with time passage.

In the analog output circuit 504 of FIG. 13, the time constant of the writing is set so that a slew rate SRc (=output current (Issc) of the voltage follower circuit/load capacity) required in starting the writing is obtained as illustrated by a curve g33. However, in the analog output circuit 1 of FIG. 12, during a period of time taken for the potential of the output terminal N to vary from the initial potential to the reference potential Vref as illustrated by a curve g31, the voltage source V1 having a lower output impedance is used, so that the potential of the output terminal N rises at a greater slew rate in starting the writing. Further, in the analog output circuit of FIG. 12, during a period of time taken for the potential of the output terminal N vary from the reference potential Vref to the reference potential Vref1 as illustrated by a curve g32, the potential is written by the voltage source V2, the time constant of the writing is set so that a slew rate SRc (=output current (Issc) of the voltage follower circuit (V2)/load capacity) required in starting the writing is obtained. The analog output circuit 1 of FIG. 12 can start the writing at a greater slew rate than that of the analog output circuit 504 of FIG. 13, and accordingly the time taken for the potential of the output terminal N to finally attain the reference potential Vref1 due to a lower output current can be made equal to or shorter than the time in the analog output circuit 504 of FIG. 3.

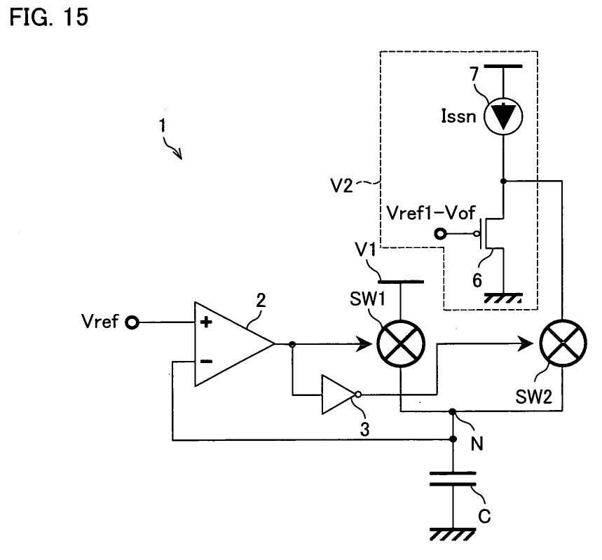

FIG. 15 illustrates a fifth specific example of the combination of the voltage sources V1 and V2. The voltage source V1 of FIG. 15 includes a power source line extended from a direct current stabilized power supply, and the voltage source V2 includes a source follower circuit using a MOS transistor 6 as in the voltage source V1 of FIG. 9. A current outputted from the constant current source 7 is Issn. Herein, a gate-source voltage, i.e., an offset voltage Vof of the MOS transistor 6 with the source follower circuit in a steady state is free from any unevenness caused by a manufacturing condition or the like. A reference potential Vref1-offset voltage Vof is inputted to a gate of the MOS transistor 6, and the reference potential Vref1 is outputted from a source of the MOS transistor 6.

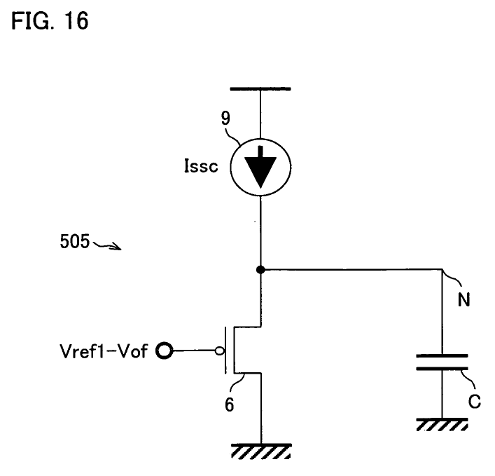

Besides, FIG. 16 illustrates an arrangement of a conventional analog output circuit 505 in which a potential is written onto the capacitive load C only by the source follower circuit. However, a constant current source is used as a constant current source 9, and a current outputted therefrom is Issc.

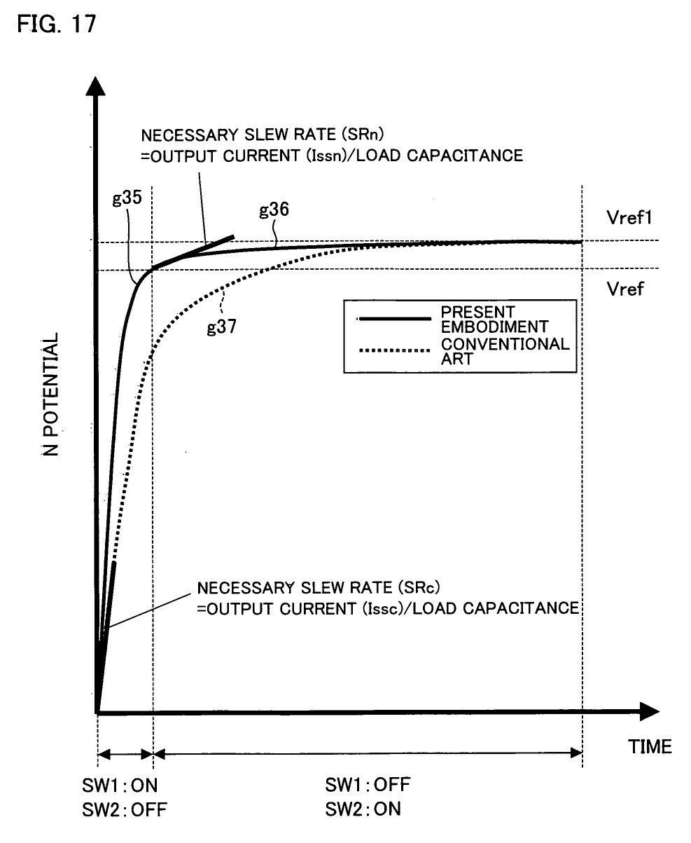

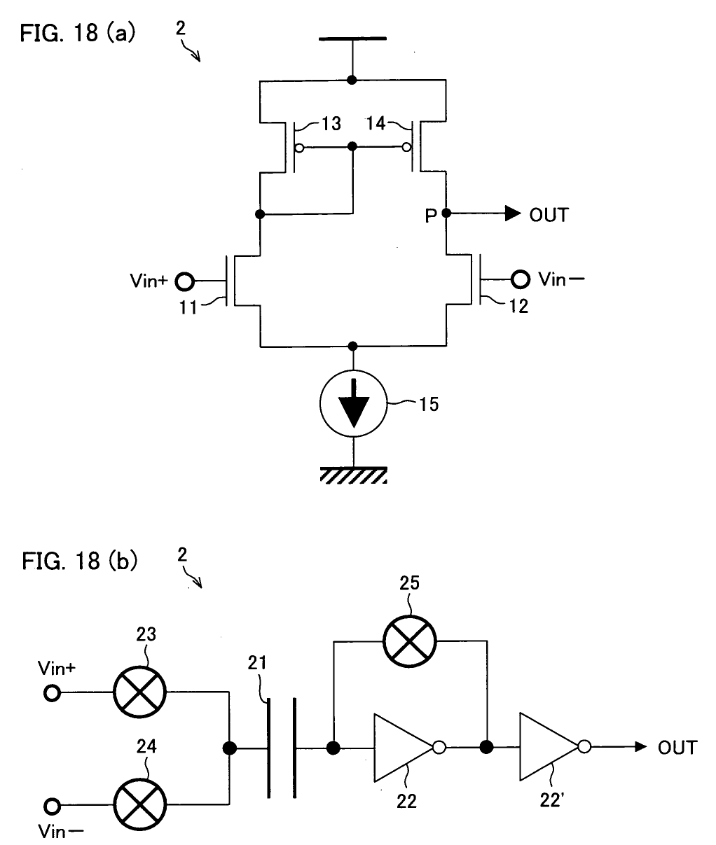

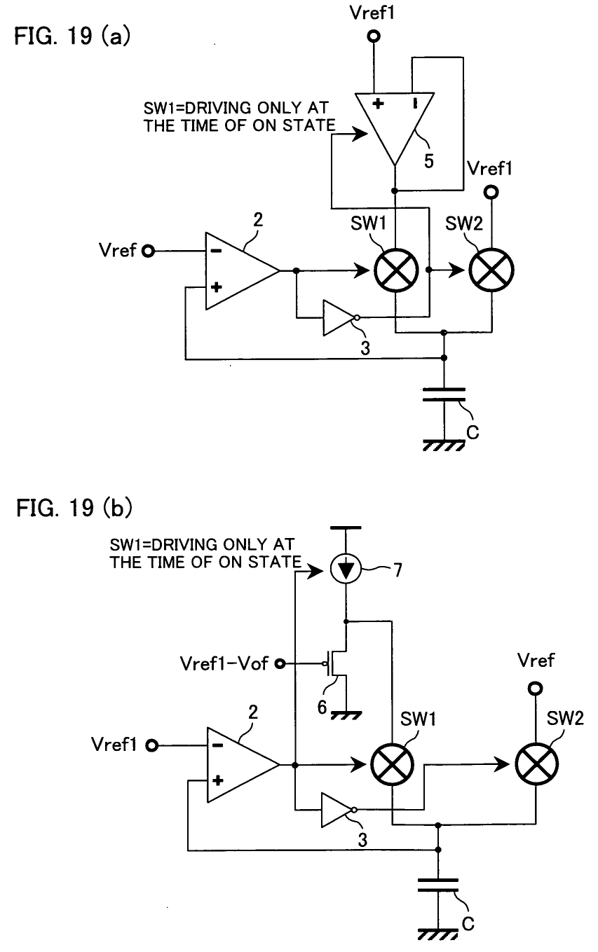

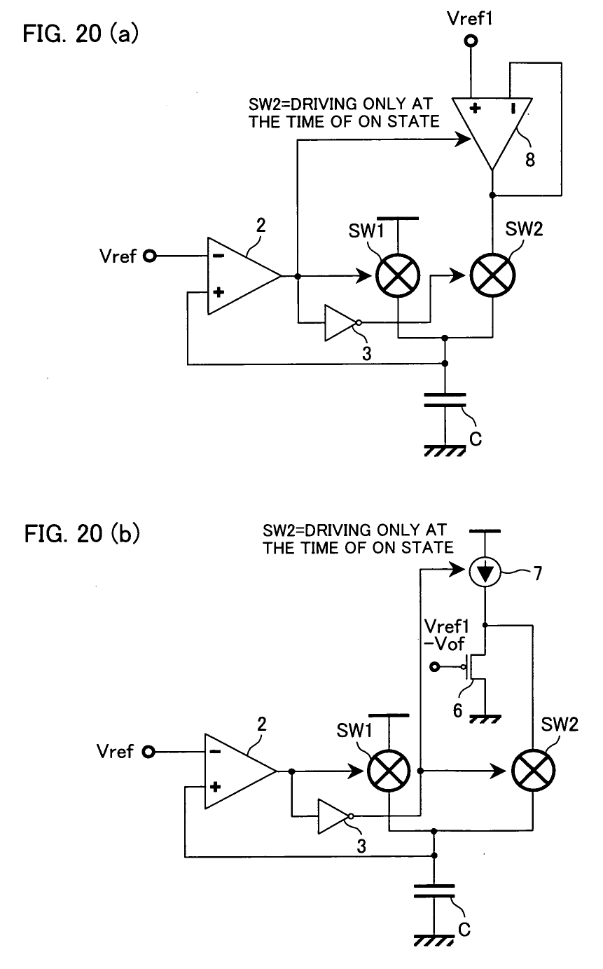

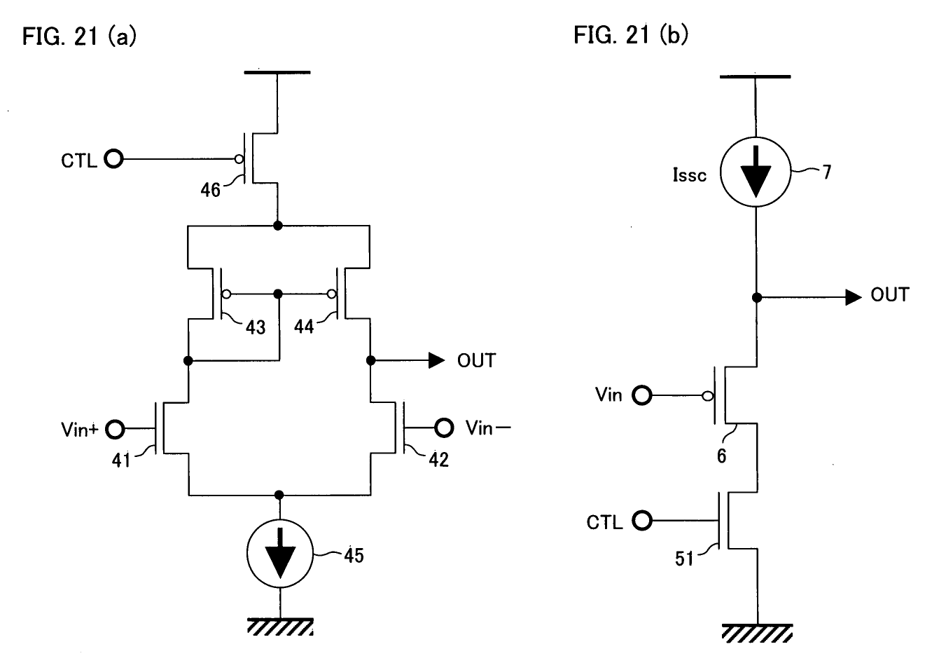

FIG. 17 illustrates how a potential of the output terminal N of the analog output circuit 1 of FIG. 15 varies with time passage and how a potential of the output terminal N of the analog output circuit 505 of FIG. 16 varies with time passage.

In the analog output circuit 505 of FIG. 16, the time constant of the writing is set so that a slew rate SRc (=output current (Issc) of the voltage follower circuit/load capacity) required in starting the writing is obtained as illustrated by a curve g37. However, in the analog output circuit 1 of FIG. 15, during a period of time taken for the potential of the output terminal N to vary from the initial potential to the reference potential Vref as illustrated by a curve g35, the voltage source V1 having a lower output impedance is used, so that the potential of the output terminal N rises at a greater slew rate in starting the writing. Further, in the analog output circuit of FIG. 15, during a period of time taken for the potential of the output terminal N vary from the reference potential Vref to the reference potential Vref1 as illustrated by a curve g36, the potential is written by the voltage source V2, and the time constant of the writing is set so that a slew rate SRc (=output current (Issc) of the voltage follower circuit (V2)/load capacity) required in starting the writing is obtained. The analog output circuit 1 of FIG. 15 can start the writing at a greater slew rate than that of the analog output circuit 505 of FIG. 16, and accordingly the time taken for the potential of the output terminal N to finally attain the reference potential Vref1 due to a lower output current can be made equal to or shorter than the time in the analog output circuit 505 of FIG. 16.

In this manner, the specific examples of the combination of the voltage sources V1 and V2 are provided. Next, configuration examples of an arrangement of the comparator 2 are described as follows.

FIG. 18(a) illustrates a first configuration example of the comparator 2. The comparator 2 includes a differential amplifier and is equipped with n-channel type MOS transistors 11 and 12 and p-channel type MOS transistors 13 and 14 and a constant current source 15.

A gate of the MOS transistor 11 serves as a noninverting input terminal of the comparator 2 and receives a potential Vin+. The potential Vin+ corresponds to the reference potential Vref of FIG. 1. A gate of the MOS transistor 12 serves as an inverting input terminal of the comparator 2 and receives a potential Vin−. The potential Vin− corresponds to the potential of the output terminal N. A source of the MOS transistor 11 and a source of the MOS transistor 12 are connected to each other, and a connection portion thereof is connected to the constant current source 15.

The MOS transistor 13 and the MOS transistor 14 constitute a current mirror circuit. A gate of the MOS transistor 13 and a gate of the MOS transistor 14 are connected to each other. Further, the gate of the MOS transistor 13 is connected to a drain of the MOS transistor 13. The drain of the MOS transistor 13 is connected to a drain of the MOS transistor 11. A drain of the MOS transistor 14 is connected to a drain of the MOS transistor 12, and a connection point P thereof is connected to a side of an output terminal OUT of the comparator 2. The sources of the MOS transistors 13 and 14 are connected to a power source.

In the comparator 2 arranged in the foregoing manner, when the potential Vin+ is lower than the potential Vin−, a current flows from the outside of the output terminal OUT toward the connection point P and accordingly the output terminal OUT has a low potential, and when the potential Vin+ is higher than the potential Vin−, a current flows from the connection point P toward the output terminal OUT and accordingly the output terminal OUT has a high potential.

FIG. 18(b) illustrates a second configuration example of the comparator 2. The comparator 2 includes a capacitor 21, inverters 22 and 22′, and analog switches 23 to 25.

An end of the analog switch 23 serves as a noninverting input terminal of the comparator 2 and receives the potential Vin+. An end of the analog switch 24 serves as an inverting input terminal of the comparator 2 and receives the potential Vin−. The other end of each of the analog switches 23 and 24 is connected to an end of the capacitor 21. The other end of the capacitor 21 is connected to an input terminal of the inverter 22. An output terminal of the inverter 22 is connected to an input terminal of the inverter 22′, and an output terminal of the inverter 22′ serves as the output terminal OUT of the comparator 2. The analog switch 25 and the inverter 22 are provided in parallel.

In the comparator 2 arranged in the foregoing manner, first, the analog switch is turned OFF, and the analog switches 24 and 25 are turned ON, and there is applied to the capacitor 21a voltage which is determined by a difference between the potential Vin− and the potential of the output terminal OUT and whose logic is not defined in input/output of the inverter 22. Next, the analog switches 24 and 25 are turned OFF and the analog switch 23 is turned ON, and a potential of an end of the capacitor 21 is set to be the potential Vin+. At this time, when the potential Vin+ is lower than the potential Vin−, the potential of the other end of the capacitor 21 drops so as to be low, so that each of the inverter 22 and the inverter 22′ inverts the logic so as to output a low potential to the output terminal OUT. While, when the potential Vin+ is higher than the potential Vin−, the potential of the other end of the capacitor 21 rises so as to be high, so that each of the inverter 22 and the inverter 22′ inverts the logic so as to output a high potential to the output terminal OUT.

Next, the following explains an arrangement for further reducing power consumption in the analog output circuit 1.

An arrangement illustrated in FIG. 19(a) is different from the arrangement of FIG. 6 in that the voltage source V1 is switched between an operational state and a nonoperational state. As a control signal used therein, a signal obtained by causing the inverter 3 to invert a logic of an output signal of the comparator 2 is used, and the voltage source V1 is operated in accordance with the operation amplifier 5 only when turning ON the switch element SW1, and the operation of the voltage source V1 is stopped in accordance with the operation amplifier 5 during a period other than the period in which the switch element SW1 is turned ON. The power consumption is reduced corresponding to the stoppage of the operation of the voltage source V1 in accordance with the operation amplifier 5.

An arrangement illustrated in FIG. 19(b) is different from the arrangement of FIG. 9 in that the voltage source V1 is switched between an operational state and a nonoperational state. As a control signal used therein, an output signal of the comparator 2 is used, and the voltage source V1 is operated only when turning ON the switch element SW1, and the operation of the voltage source V1 is stopped during a period other than the period in which the switch element SW1 is turned ON. The power consumption is reduced corresponding to the stoppage of the operation of the voltage source V1.

An arrangement illustrated in FIG. 20(a) is different from the arrangement of FIG. 12 in that the voltage source V2 is switched between an operational state and a nonoperational state. As a control signal used therein, an output signal of the comparator 2 is used, and the voltage source V2 is operated in accordance with the operation amplifier 5 only when turning ON the switch element SW2, and the operation of the voltage source V2 is stopped in accordance with the operation amplifier 5 during a period other than the period in which the switch element SW2 is turned ON. The power consumption is reduced corresponding to the stoppage of the operation of the voltage source V2 in accordance with the operation amplifier 5.

An arrangement illustrated in FIG. 20(b) is different from the arrangement of FIG. 15 in that the voltage source V2 is switched between an operational state and a nonoperational state. As a control signal used therein, a signal obtained by causing the inverter 3 to invert a logic of an output signal of the comparator 2 is used, and the voltage source V2 is operated only when turning ON the switch element SW2, and the operation of the voltage source V2 is stopped during a period other than the period in which the switch element SW2 is turned ON. The power consumption is reduced corresponding to the stoppage of the operation of the voltage source V2.

Next, FIG. 21(a) illustrates a configuration example of a differential amplification stage of each of the operation amplifiers 5 and 8 capable of being switched between an operational state and a nonoperational state which operation amplifiers 5 and 8 are respectively illustrated in FIG. 19(a) and FIG. 20(a). The differential amplification stage of each of the operation amplifiers 5 and 8 includes: n-channel type MOS transistors 41 and 42; p-channel type MOS transistors 43, 44, and 46; and a constant current source 45.

A gate of the MOS transistor 41 serves as a noninverting input terminal of each of the operation amplifiers 5 and 8 and receives a potential Vin+. The potential Vin+ corresponds to the reference potential Vref1 in FIG. 6 and FIG. 12. A gate of the MOS transistor 42 serves as an inverting input terminal of each of the operation amplifiers 5 and 8 and receives a potential Vin−. The potential Vin− corresponds to the output potential of each of the operation amplifiers 5 and 8 in FIG. 6 and FIG. 12. A source of the MOS transistor 41 and a source of the MOS transistor 42 are connected to each other, and a connection point thereof is connected to a constant current source 45.

The MOS transistor 43 and the MOS transistor 44 constitute a current mirror circuit. The gate of the MOS transistor 43 and the gate of the MOS transistor 44 are connected to each other. Further, the gate of the MOS transistor 43 is connected to a drain of the MOS transistor 43. The drain of the MOS transistor 43 is connected to a drain of the MOS transistor 41. A drain of the MOS transistor 44 is connected to a drain of the MOS transistor 42, and a connection point thereof is connected to a side of an output terminal OUT of each of the operation amplifiers 5 and 8. A source of the MOS transistor 46 is connected to a power source, and a drain of the MOS transistor 46 is connected to a source of each of the MOS transistors 43 and 44.

A control signal CTL for controlling an operational state and a nonoperational state of each of the operation amplifiers 5 and 8 is inputted to a gate of the MOS transistor 46. The control signal corresponds to the output signal of the inverter 3 of FIG. 19(a) and also corresponds to the output signal of the comparator 2 of FIG. 20(a). When the control signal CTL is low, the MOS transistor 46 is turned ON so as to operate the operation amplifiers 5 and 8. When the control signal CTL is high, the MOS transistor 46 is turned OFF so as to stop operation of the operation amplifiers 5 and 8.

Further, FIG. 21(b) illustrates a configuration example of a source follower circuit capable of being switched between an operational state and a nonoperational state which are respectively illustrated in FIG. 19(b) and FIG. 20(b). The source follower circuit includes not only the MOS transistor 6 and the constant current source 7 but also an n-channel type MOS transistor 51. A source of the MOS transistor 51 is connected to GND, and a drain of the MOS transistor 51 is connected to a drain of the MOS transistor 6. A control signal CTL for controlling an operational state and a nonoperational state of the source follower circuit is inputted to a gate of the MOS transistor 51. The control signal CTL corresponds to the output signal of the comparator 2 in FIG. 19(b) and corresponds to the output signal of the inverter 3 in FIG. 20(b). When the control signal CTL is high, the MOS transistor is turned ON so as to allow the source follower circuit to operate. When the control signal is low, the MOS transistor 51 is turned OFF so as to stop the operation of the source follower circuit.

Next, the following describes a method for driving the analog output circuit 1 of the present embodiment.

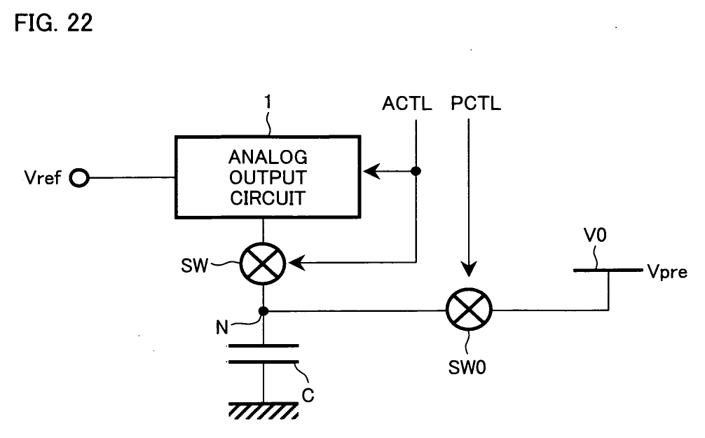

FIG. 22 illustrates an arrangement for realizing a first driving method in which the analog output circuit 1 is used to write a predetermined potential onto the capacitive load C. With this arrangement, a voltage source V0 is provided, and the voltage source V0 initializes the potential of the capacitive load C into a potential Vpre in advance, and then a potential higher than the potential Vpre is written onto the capacitive load C or a potential lower than the potential Vpre is written onto the capacitive load C. A switch element of FIG. 22 represents the switch elements SW1 and SW2 of FIG. 1 in a simple manner. The voltage source V0 is connected to the capacitive load C via a switch element SW0.

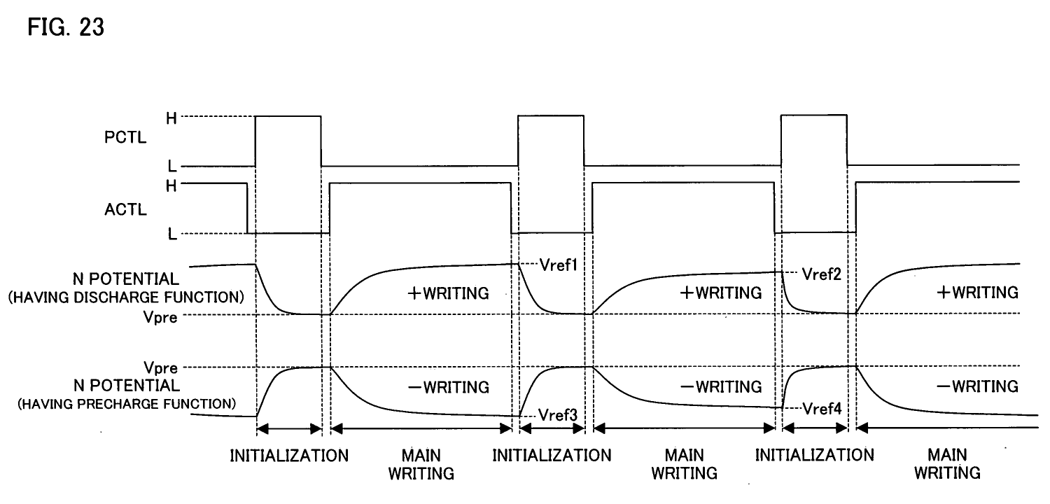

To each of the analog output circuit 1 and the switch element SW, a control signal ACTL for controlling whether or not to operate them is inputted. To the switch element SW0, a control signal PCTL for controlling whether to turn ON or to turn OFF the switch element SW0 is inputted. FIG. 23 illustrates waveforms of the control signals ACTL and PCTL. The analog output circuit 1 and the switch element SW are capable of operating when the control signal ACTL is high, and the analog output circuit 1 and the switch element SW are not capable of operating when the control signal ACTL is low. The switch element SW0 is turned ON when the control signal PCTL is high, and the switch element SW0 is turned OFF when the control signal PCTL is low.

As apparent from FIG. 23, before writing a predetermined potential onto the capacitive load C, the control signal PCTL is set to be high so as to turn ON the switch element SW0, thereby providing an initialization period. At least during the initialization period, the control signal ACTL is low, so that the writing operation cannot be carried out by the analog output circuit 1. Further, after the initialization period, the control signal ACTL becomes high, which results in a main writing period in which a predetermined potential is written onto the capacitive load C by the analog output circuit 1.

Herein, in case where a voltage source of the analog output circuit 1 writes a potential higher than the initial potential of the capacitive load C, a potential Vpre of the voltage source V0 is set to be an initial potential lower than the writing potential. In this case, a process for initializing the capacitive load C is such that electric charge having been written onto the capacitive load is discharged. During the main writing period, as illustrated by “+writing” in FIG. 23, writing is carried out only in a single direction toward a potential higher than the potential Vpre. As the predetermined potential, an arbitrary number of potentials such as Vref1, Vref2, can be set as illustrated in FIG. 23.

Further, in case where the voltage source of the analog output circuit 1 writes a potential lower than the initial potential of the capacitive load C, the potential Vpre of the voltage source V0 is set as an initial potential higher than the writing potential. In this case, a process for initializing the capacitive load C is such that precharge is carried out so as to cover insufficient electric charge having been written onto the capacitive load C. During the main writing period, as illustrated by “−writing” in FIG. 23, writing is carried out only in a single direction toward a potential lower than the potential Vpre. As the predetermined potential, an arbitrary number of potentials such as Vref3, Vref4, . . . , can be set as illustrated in FIG. 23.

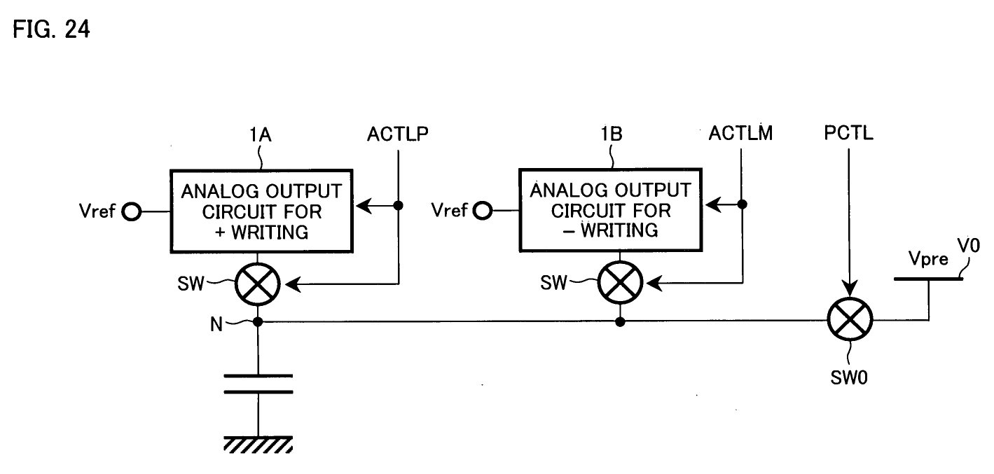

FIG. 24 illustrates an arrangement for realizing a second driving method in which the analog output circuit 1 is used to write a predetermined potential onto the capacitive load C. With this arrangement, two types of the analog output circuit 1 are provided as an analog output circuit 1A and an analog output circuit 1B. To each of the analog output circuit 1A and a corresponding switch element SW, a control signal ACTLP for controlling whether or not to operate them is inputted. To each of the analog output circuit 1B and a corresponding switch element SW, a control signal ACTLM for controlling whether or not to operate them is inputted. The analog output circuit 1A carries out the +writing so as to write a predetermined potential onto the capacitive load C so that the potential varies in a direction from a lower side toward a higher side, and the analog output circuit 1B carries out the −writing so as to write a predetermined potential onto the capacitive load C so that the potential drops in a direction from a higher side toward a lower side.

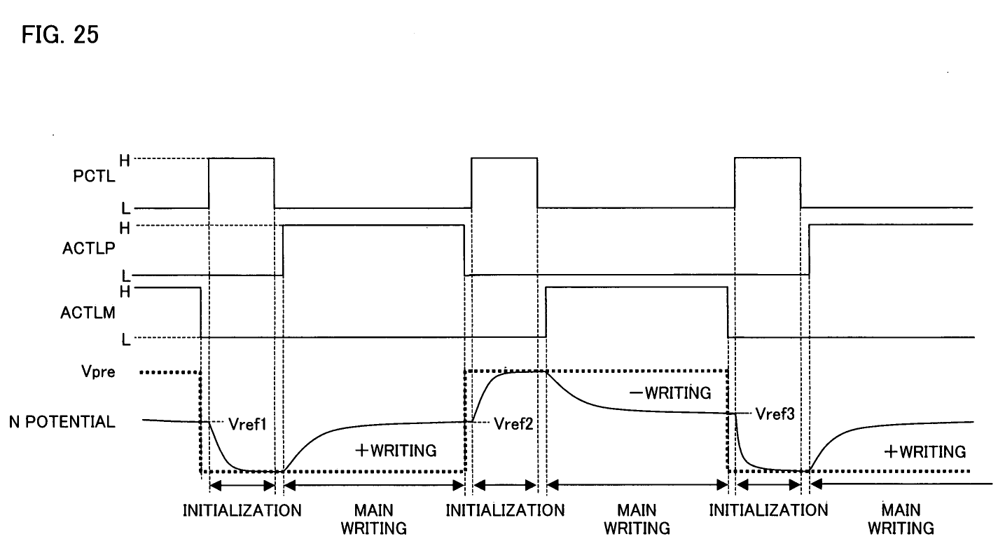

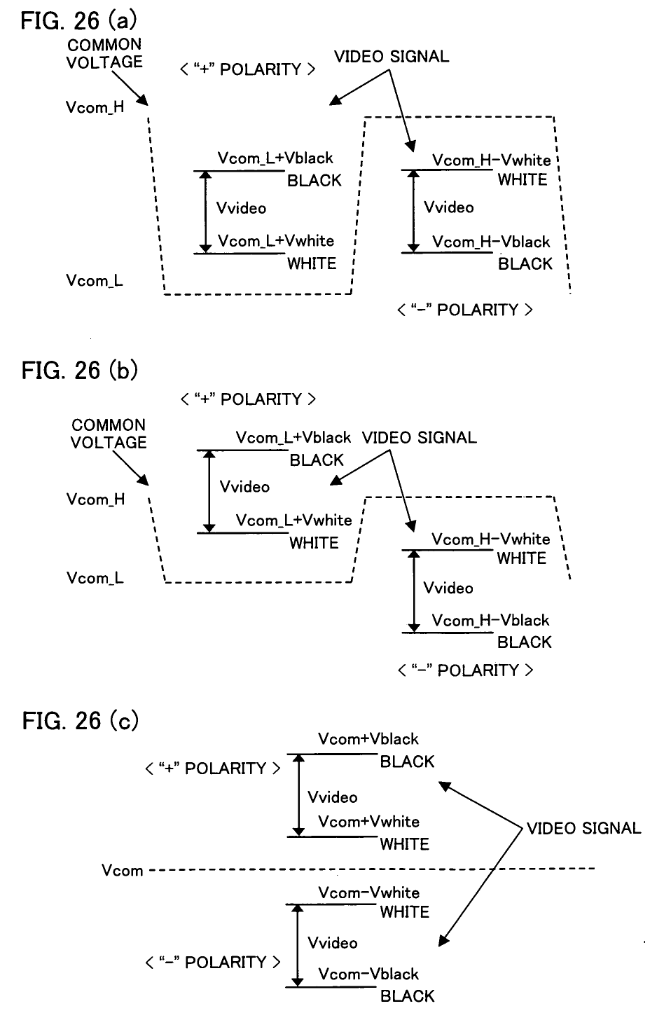

As illustrated in FIG. 25, high periods of the control signals ACTLP, ACTLM, and PCTL do not overlap with each other. With the arrangement of FIG. 24, in order to alternately carry out the +writing of the analog output circuit 1A and the −writing of the analog output circuit 1B, initial potentials thereof are different from each other in the initialization period. In the initialization period before the main writing period for carrying out the +writing, the potential Vpre is set to be lower than the predetermined potential to be written. In the initialization period before the main writing period for carrying out the −writing, the potential Vpre is set to be higher than the predetermined potential to be written. Thus, the potential Vpre of the voltage source V0 of FIG. 24 is variable. As the predetermined potential, an arbitrary number of potentials such as Vref1, Vref2, Vref3, . . . , can be set as illustrated in FIG. 24.

The arrangements illustrated in FIG. 24 and FIG. 25 are applicable to various driving operations. An example thereof is illustrated in FIG. 26. Each of FIG. 26(a) to FIG. 26(c) illustrates a relation among an anode voltage of a video signal, a cathode voltage of the video signal, and a common voltage in carrying out AC driving with respect to a liquid crystal panel of a liquid crystal display device.

FIG. 26(a) illustrates a case where the common voltage oscillates with a great amplitude. As to the anode voltage, a low common voltage Vcom_L is regarded as a common voltage. As to the cathode voltage, a high common voltage Vcom_H is regarded as a common voltage. A potential range video Vvideo of an anode video signal is indicated as a range between white level (Vcom_L)+Vwhite and black level (Vcom_L)+Vblack, and a potential range Vvideo of a cathode video signal is indicated as a range between white level (Vcom_H)−Vwhite and black level (Vcom_H)−Vblack. Vcom_L+Vblack=Vcom_H−Vwhite, and Vcom_L+Vwhite=Vcom_H−Vblack. In this case, the arrangements of FIG. 24 and FIG. 25 can be used with the high common voltage Vcom_H and the low common voltage Vcom_L regarded as the potential Vpre.

FIG. 26(b) illustrates a case where the common voltage oscillates with a small amplitude. As to the anode voltage, a low common voltage Vcom_L is regarded as a common voltage. As to the cathode voltage, a high common voltage Vcom_H is regarded as a common voltage. A potential range Vvideo of an anode video signal is indicated as a range between white level (Vcom_L)+Vwhite and black level (Vcom_L)+Vblack, and a potential range Vvideo of a cathode video signal is indicated as a range between white level (Vcom_H)−Vwhite and black level (Vcom_H)−Vblack. Vcom_L+Vblack>Vcom_H−Vwhite. Also in this case, the arrangements of FIG. 24 and FIG. 25 can be used with the high common voltage Vcom_H and the low common voltage Vcom_L regarded as the potential Vpre.

FIG. 26(c) illustrates a case where the common voltage has a constant value. The anode voltage has a higher potential than that of the common voltage Vcom, and the cathode voltage has a lower potential than that of the common voltage Vcom. A potential range Vvideo of an anode video signal is indicated as a range between white level Vcom+Vwhite and black level Vcom+Vblack, and a potential range Vvideo of a cathode video signal is indicated as a range between white level Vcom−Vwhite and black level Vcom−Vblack. In this case, the potential Vpre is made constant in the arrangements of FIG. 24 and FIG. 25.

Note that, as illustrated in FIG. 26(b) and FIG. 26(c), the initialization does not have to be carried out with the potential Vpre in case where the potential range Vvideo of the anode voltage and the potential range Vvideo of the cathode voltage do not overlap each other.

Next, the following describes an example of an arrangement of (i) a liquid crystal display device including the analog output circuit 1 of the present embodiment and (ii) a data signal line driving circuit thereof.

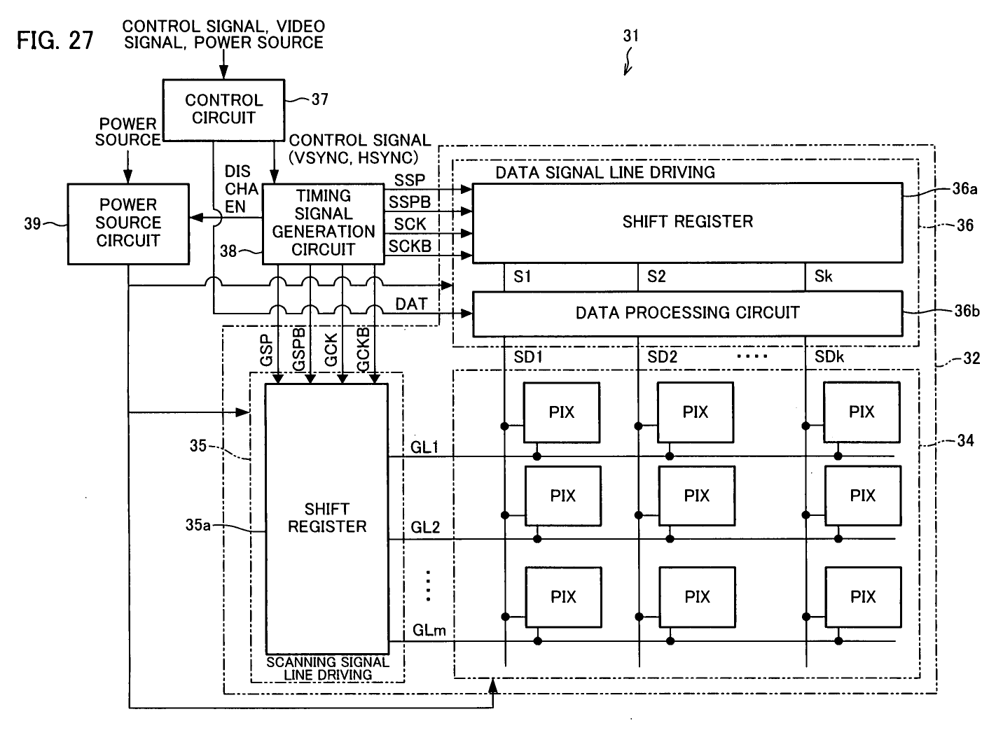

FIG. 27 is a block diagram of a liquid crystal display device 31 according to the present embodiment. Schematically, the liquid crystal display device 31 includes a display panel 32, a control circuit 37, a timing signal generation circuit 38, and a power source circuit 39. The display panel 32 includes a display section 34 having pixels PIX disposed in a matrix manner, a scanning signal line driving circuit 35, and a data signal line driving circuit 36 each of which drives the pixels PIX. The scanning signal line driving circuit 35 includes a shift register 35a, and the data signal line driving circuit 36 includes a shift register 36a and a data processing circuit 36b.

The display section 34 is formed on the substrate, on which the scanning signal line driving circuit 35 and the data signal line driving circuit 36 are formed, in a monolithic manner so as to save the trouble in manufacturing and reduce the wiring capacitance. Further, in order that a larger number of pixels PIX are integrated and a larger display area is secured, each of the display section 34, the scanning signal line driving circuit 35, and the data signal line driving circuit 36 is constituted of a thin film transistor made of polycrystal silicon or CG silicon formed on the glass substrate. Further, the thin film transistor is formed at a process temperature not higher than 600° C. so that warpage or deflection caused by a process temperature not lower than a strain point does not occur even when a general glass substrate whose strain point is 600° C. or lower is used.

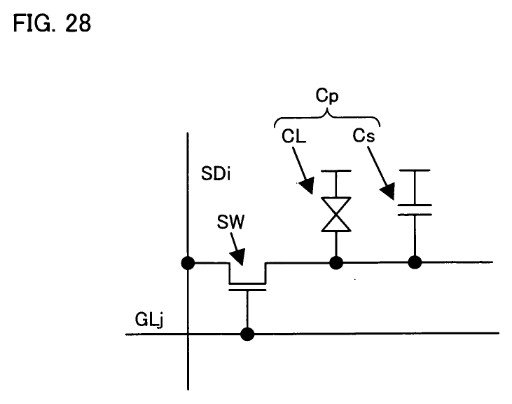

The display section 34 displays an image as follows. An area of the pixels PIX is formed with it sectioned by m number of scanning signal lines GL1 to GLm and k number of data signal lines SD1 to SDk so that both the lines intersect with each other, and the scanning signal line driving circuit 35 and the data signal line driving circuit 36 sequentially write video signals (data signals) DAT, supplied from the control circuit 37, to the pixels PIX via the scanning signal lines GL1 to GLm and the data signal lines SD1 to SDk, thereby displaying an image. Each of the pixels PIX is arranged as illustrated in FIG. 28. In FIG. 28, as in the scanning signal line GL and the data signal line SD, an arbitrary integer “i” which is indicative of a larger number than the aforementioned “k” as an address and an arbitrary integer “j” which is indicative of a larger number than the aforementioned “m” as an address are given to each pixel PIX.

The pixel PIX includes: a field effect transistor (switching element) SW whose gate is connected to the scanning signal line GL and whose source is connected to the data signal line SD; and a pixel capacitance Cp whose one electrode is connected to a drain of the field effect transistor SW. The other electrode of the pixel capacitance Cp is connected to a common electrode line shared by all the pixels PIX. The pixel capacitance Cp includes a liquid crystal capacitance CL and an auxiliary capacitance Cs which is added as necessary.

Thus, when the scanning signal line BGL is selected, the field effect transistor SW is turned ON, so that a voltage applied to the data signal line SD is applied to the pixel capacitor Cp. While, during a period in which the field effect transistor SW is kept OFF after the selection period of the scanning signal line GL, the pixel capacitor Cp keeps the voltage at the same level as that at the time of turning OFF the field effect transistor SW. Herein, a transmittance or a reflectivity of liquid crystal varies depending on a voltage applied to the liquid crystal capacitor CL. Thus, the scanning signal line GL is selected and a voltage corresponding to the video signal DAT is applied to the data signal line, thereby changing a display state of the pixel PIX in accordance with the data signal DAT.

Herein, the video signal DAT for each pixel PIX is transmitted from the control circuit 37 to the data signal line driving circuit 36 in a time divisional manner. The data signal line driving circuit 36 extracts, from the video signal DAT, video data for each pixel PIX at a timing based on a source clock signal SCK and its inversion signal SCKB and a source start pulse SSP and its inversion signal SSPB which are inputted from a timing signal generation circuit 38 as a timing signal and whose duty ratio at a predetermined cycle is 50% (also a value not more than 50% is applicable). Specifically, the shift register 36a sequentially shifts the source start pulses SSP and SSPB in synchronization with an ON timing of the inputted source clock signals SCK and SCKB, so that there are generated output signals S1 to Sk which are respectively indicative of timings deviating from timings indicated by the source clock signals SCK and SCKB with each deviation corresponding to every half cycle, and the data processing circuit 36b samples the video signals DAT at timings indicated by the output signals S1 to Sk and outputs the sampled video signals DAT to the data signal lines SD1 to SDk. As analog voltages outputted to the data signal lines SD1 to SDk, a power source voltage supplied from the power source circuit 39 to the data signal line driving circuit 36 is used.

Likewise, in the scanning signal line driving circuit 35, the shift register 35a sequentially shifts the gate start pulses GSP and GSPB in synchronization with the gate clock signals GCK and GCKB inputted from the timing signal generation circuit 38 so as to output scanning signals, whose timings respectively deviate from each other at predetermined intervals, to the scanning signal lines GL1 to GLm.

The timing signal generation circuit 38 generates timing signals such as the source clock signals SCK and SCKB, the source start pulses SSP and SSPB, the gate clock signals GCK and GCKB, and the gate start pulses GSP and GSPB. Out of these timing signals, the gate start pulses GSP and GSPB each of which serves as a display driving control signal are generated particularly in synchronization with a signal VSYNC which is a vertical synchronization signal inputted from the control circuit 37. Likewise, the timing signal generation circuit 38 generates a power source control signal for controlling the power source circuit 39, such as a discharge signal DIS, a charge signal CHA, and an enable signal EN, in synchronization with the signal VSYNC which is a vertical synchronization signal inputted from the control circuit 37, so as to input the power source control signal to the power source circuit 39. Herein, the discharge signal DIS is a control signal for causing an internal part of the power source circuit 39 to be discharged in starting up the power source circuit 39. The charge signal CHA is a control signal for causing the power source circuit 39 to be charged so as to be ready for the start up after causing the discharge signal DIS to discharge the power source circuit 39. The enable signal EN is a control signal for validating a clock signal, causing the power source circuit 39 to operate, after causing the charge signal CH to charge the power source circuit 39. Note that, the timing signal generation circuit 38 also can generate the source start pulses SSP and SSPB in synchronization with a horizontal synchronization signal HSYNC and a dot clock signal.

The control circuit 37 generates the video signal DAT, the signals VSYNC and HSYNC, and the like, in accordance with a control signal and a video signal. Further, power is supplied from a power source section of the liquid crystal display device 31 to the control circuit 37 and the power source circuit 39. The power source circuit 39 supplies not only power to be outputted to the data signal lines SD1 to SDk but also power to the scanning signal line driving circuit 35 and common voltage power to the display section 34.

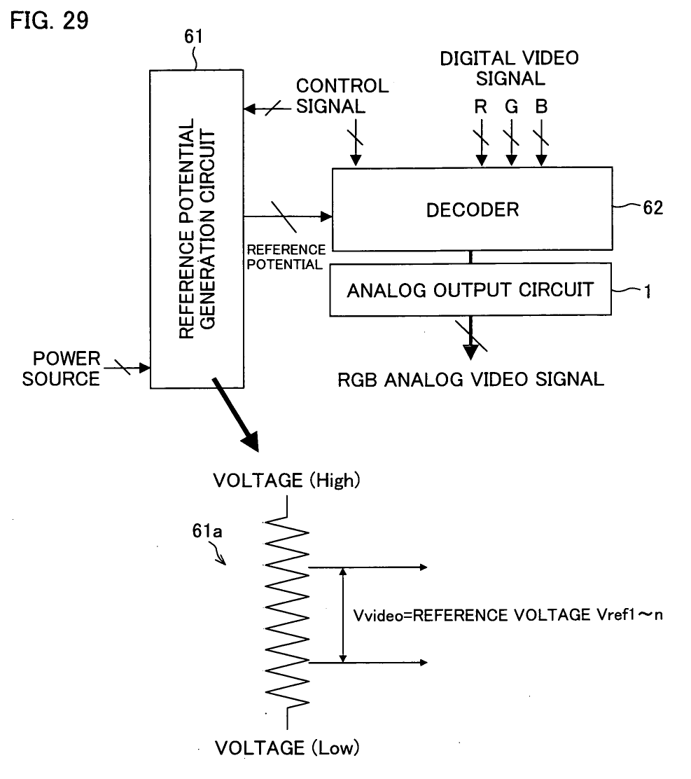

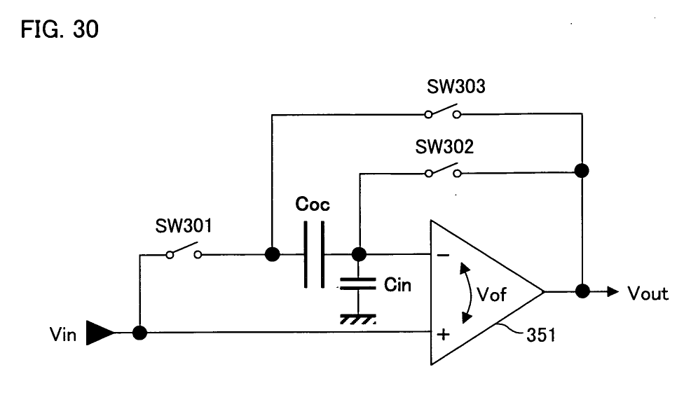

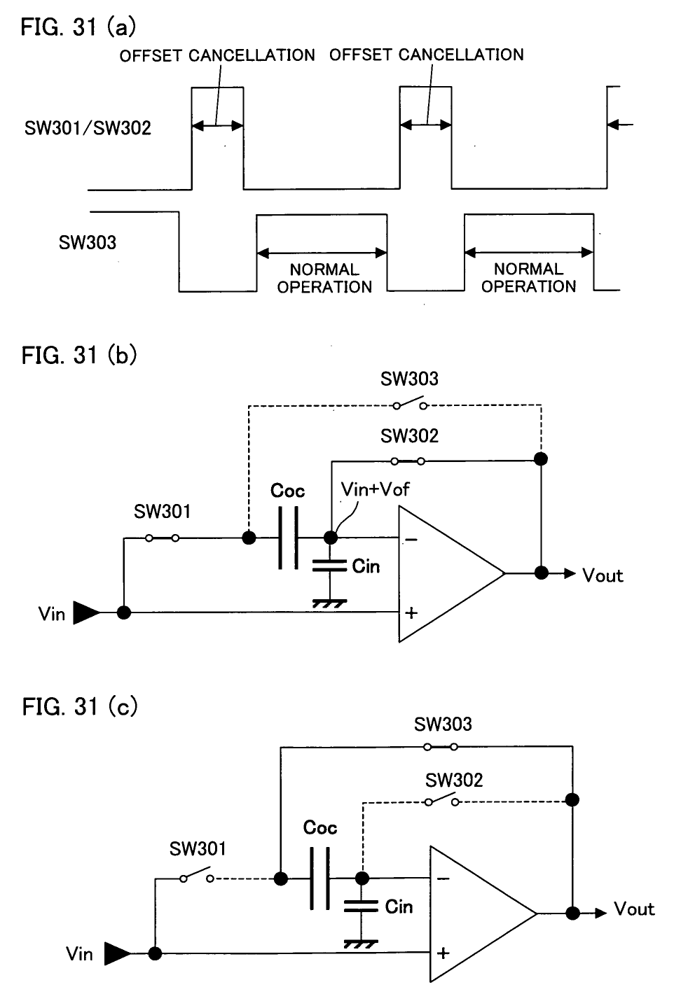

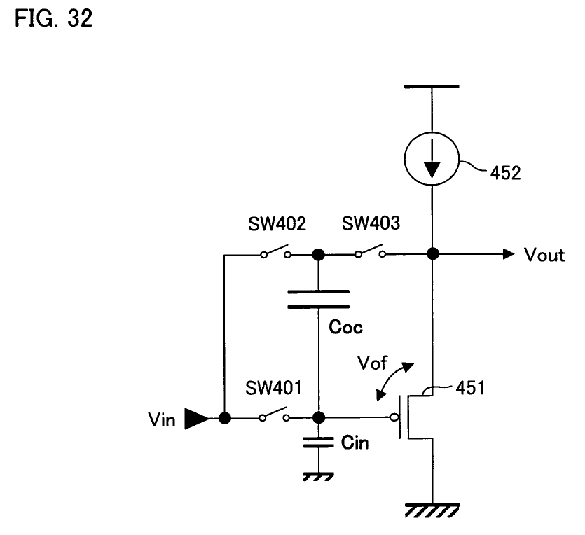

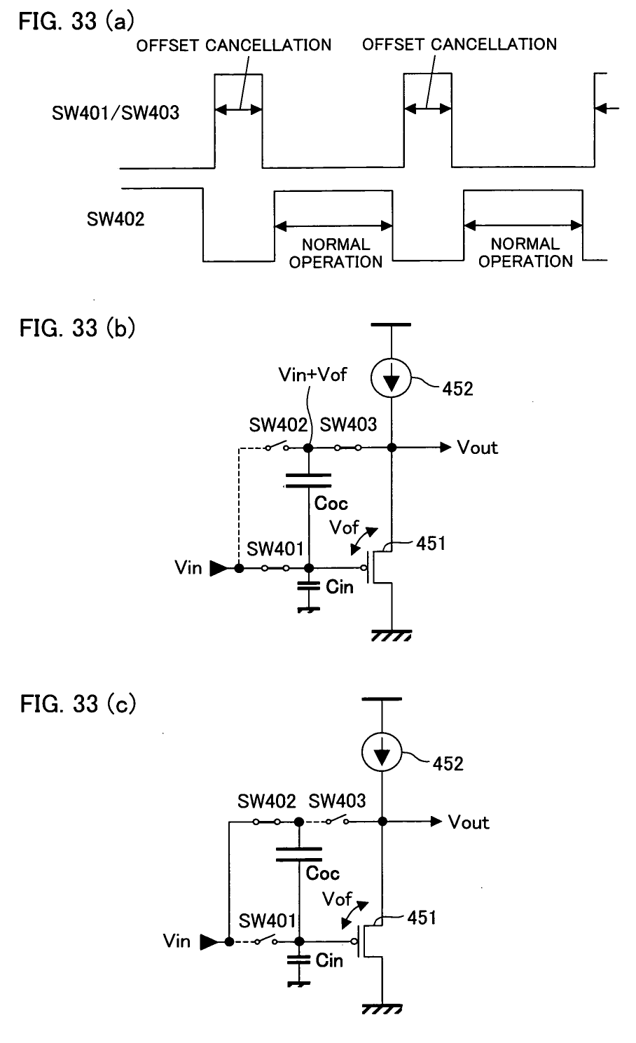

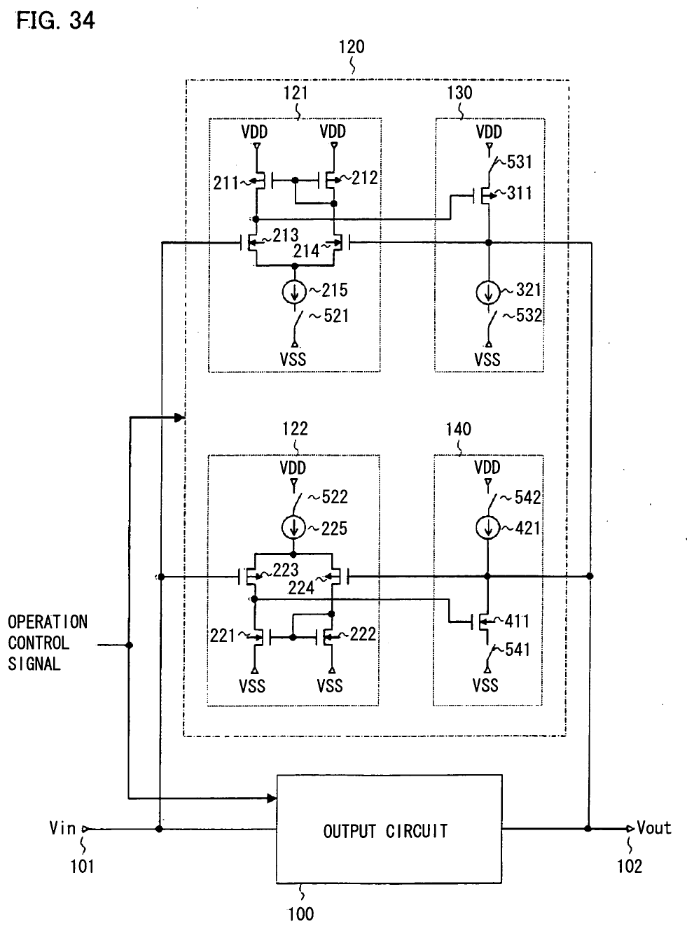

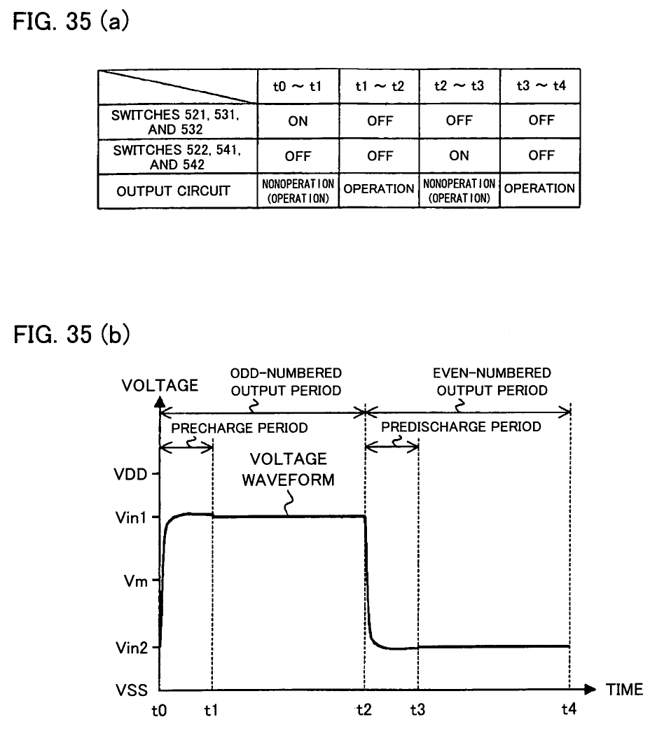

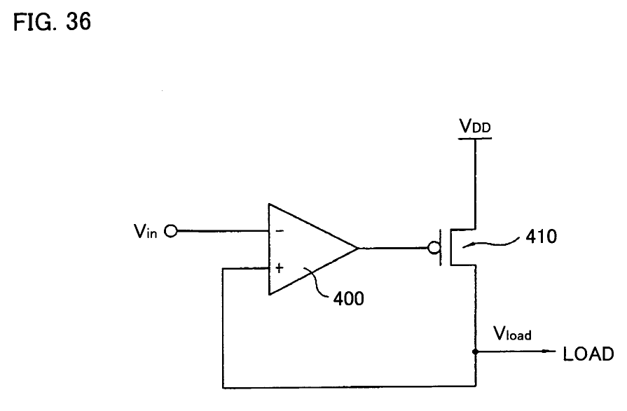

Next, FIG. 29 illustrates an arrangement of the data processing circuit 36b of FIG. 27.

The data processing circuit 36b is formed with it integrated to the liquid crystal panel by using polycrystal silicon or CG silicon, and includes the analog output circuit 1 and a decoder 62. Note that, the reference potential generation circuit 61 is arranged as the power source circuit of FIG. 27, but the reference potential generation circuit 61 may be included in the data processing circuit 36b.

To the decoder 62, R,G,B digital video signals DAT are inputted. The decoder 62 carries out D/A conversion of each video signal DAT by using the reference potential inputted from the reference potential generation circuit 61. The analog output circuit 1 uses an analog voltage obtained by carrying out the D/A conversion as the reference potential Vref1 of the voltage source V2 illustrated in FIG. 3, FIG. 6, FIG. 9 and somewhere, so as to output R,G,B analog video signals to the data signal lines SD1 to SDk. As a result, the analog output circuit 1 writes potentials of the analog video signals onto the data signal lines SD1 to SDk. Note that, the reference potential generation circuit 61 causes a resistance string 61a to divide each voltage in a potential range Vvideo between a voltage (Low) obtained from an external power source and a voltage (High) so as to generate the reference potentials Vref1 to Vrefn.

The foregoing description explained the present embodiment. In the foregoing description, two types of voltage sources are provided, but the present invention is not limited to this, and the number of voltage sources may be arbitrarily plural. Further, at this time, the voltage sources used in the writing are sequentially switched in such an order that a voltage source having a lower output impedance is more preferentially switched, thereby obtaining the aforementioned effect. Further, the capacitive load is not limited to the data signal line, and a pixel capacitor or a common electrode whose potential illustrated in FIG. 26(a) and FIG. 26(b) oscillates can be used as the capacitive load.

Further, the analog output circuit of the present invention may include initialization means for initializing the potential of the capacitive load so that the potential is lower or higher than a potential of each of the voltage sources.

According to the invention, the initialization means can initialize the potential of the capacitive load. Thus, in case where the initialization potential is lower than a predetermined potential written onto the capacitive load, potentials of all the voltage sources are made higher than the initialization potential so as to carry out the writing in a single direction from the lower potential side to the higher potential side. In case where the initial potential is higher than the predetermined potential written onto the capacitive load, potentials of all the voltage sources are made lower than the initialization potential so as to carry out the writing in a single direction from the higher potential side to the lower potential side. This is the effect obtained by the present invention.

Further, the analog output circuit of the present invention may be arranged so that: the voltage sources include: a first voltage source for writing, onto the capacitive load, a first potential serving as the predetermined potential so that the potential rises; and a second voltage source for writing, onto the capacitive load, a second potential serving as the predetermined potential so that the potential drops, wherein the potential monitoring means includes: first potential monitoring means corresponding to the first voltage source; and second potential monitoring means corresponding to the second voltage source, wherein a control signal indicative of whether to write the first potential or to write the second potential is inputted from the outside.

According to the invention, the analog output circuit include: the first voltage source for writing the first potential onto the capacitive load so that the potential rises; the first potential monitoring means corresponding to the first voltage source; the second voltage source for writing the second potential onto the capacitive load in so that the potential drops; and the second potential monitoring means corresponding to the second voltage source, wherein the control signal indicative of whether to write the first potential or to write the second potential is inputted from the outside. Thus, it is possible to realize both (i) the writing carried out so that the potential of the capacitive load rises and (ii) the writing carried out so that the potential of the capacitive load drops.

Further, the analog output circuit of the present invention may be arranged so that the capacitive load is a data signal line of an active matrix type display device, and the analog output circuit serves as an output circuit of a data signal line driving circuit.

According to the invention, it is possible to exhibit such effect that a desired potential can be written onto the data signal line with a simple arrangement, low power consumption, high speed, and high accuracy, in an active matrix type display device.

Further, the analog output circuit of the present invention may be arranged so that one of the voltage sources is a reference potential generation circuit for generating a reference potential of the data signal as the predetermined potential.

According to the invention, the reference potential generation circuit for generating a reference potential of the data signal is used as the voltage source for writing the predetermined potential onto the data signal line, so that the analog output circuit can favorably exhibit its performance in a display device including a reference potential generation circuit serving as a voltage source having a high output impedance.

Further, the analog output circuit of the present invention may be arranged so that the voltage sources include two voltage sources as: a power source line which serves as a voltage source having a lower output impedance and is extended from a direct current stabilized power supply; and a voltage dividing circuit which serves as a voltage source having a higher output impedance and divides a voltage obtained from the power source line extended from the direct current stabilized power supply.

According to the invention, it is possible to easily realize the writing of a potential onto the capacitive load by the voltage source having a lower output impedance and the voltage source having a higher output impedance.

Further, the analog output circuit of the present invention may be arranged so that the voltage sources include two voltage sources as: a voltage follower circuit which serves as a voltage source having a lower output impedance; and a voltage dividing circuit which serves as a voltage source having a higher output impedance and divides a voltage obtained from a power source line extended from a direct current stabilized power supply.

According to the invention, it is possible to easily realize the writing of a potential onto the capacitive load by the voltage source having a lower output impedance and the voltage source having a higher output impedance.

Further, the analog output circuit of the present invention may be arranged so that the voltage sources include two voltage sources as: a source follower circuit which serves as a voltage source having a lower output impedance; and a voltage dividing circuit which serves as a voltage source having a higher output impedance and divides a voltage obtained from a power source line extended from a direct current stabilized power supply.

According to the invention, it is possible to easily realize the writing of a potential onto the capacitive load by the voltage source having a lower output impedance and the voltage source having a higher output impedance.

Further, the analog output circuit of the present invention may be arranged so that the voltage sources include two voltage sources as: a power source line which serves as a voltage source having a higher output impedance and is extended from a direct current stabilized power supply; and a voltage follower circuit which serves as a voltage source having a lower output impedance.

According to the invention, it is possible to easily realize the writing of a potential onto the capacitive load by the voltage source having a lower output impedance and the voltage source having a higher output impedance.

Further, the analog output circuit of the present invention may be arranged so that the voltage sources include two voltage sources as: a power source line which serves as a voltage source having a higher output impedance and is extended from a direct current stabilized power supply; and a source follower circuit which serves as a voltage source having a lower output impedance.

According to the invention, it is possible to easily realize the writing of a potential onto the capacitive load by the voltage source having a lower output impedance and the voltage source having a higher output impedance.

Further, a data signal line driving circuit of the present invention may include the aforementioned analog output circuit.

According to the invention, it is possible to realize a data signal line driving circuit which can write a desired potential onto the data signal line with a simple arrangement, low power consumption, high speed, and high accuracy.

Further, a display device of the present invention may include the aforementioned data signal line driving circuit.

According to the invention, it is possible to realize a display device which can write a desired potential onto the data signal line with a simple arrangement, low power consumption, high speed, and high accuracy.

Further, a potential writing method of the present invention is a method in which the analog output circuit is used to write the predetermined potential onto the capacitive load, and the method may include a step of causing the potential monitoring means to carry out the ON/OFF control so as to cause the voltage sources to be electrically connected to the capacitive load sequentially in such an order that a voltage source having a lower output impedance is electrically connected more preferentially.

According to the invention, the potential monitoring means carries out the ON/OFF control so as to cause the voltage sources to be electrically connected to the capacitive load sequentially in such an order that a voltage source having a smaller output impedance is electrically connected more preferentially, so that it is possible particularly to write a desired potential onto the capacitive load with low power consumption, high speed, and high accuracy.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is favorably applicable to a liquid crystal display device.

1. An analog output circuit, writing a predetermined potential onto a capacitive load,
said analog output circuit comprising:
a plurality of voltage sources whose output impedances are different from each other, one of the voltage sources which has the highest output impedance outputting the predetermined potential;
switch elements which respectively correspond to the voltage sources so as to be turned ON/OFF so that each of the voltage sources is electrically connected/disconnected to/from the capacitive load; and
potential monitoring means which carries out an ON/OFF control for detecting a potential of the capacitive load and determining one of the switch elements, in accordance with the detected potential of the capacitive load, so as to turn ON the switch element having been determined and so as to turn OFF other switch elements.

2. The analog output circuit as set forth in claim 1, further comprising initialization means for initializing the potential of the capacitive load so that the potential is lower or higher than a potential of each of the voltage sources.

3. The analog output circuit as set forth in claim 1, wherein the voltage sources include: a first voltage source for writing, onto the capacitive load, a first potential serving as the predetermined potential in such direction that the potential rises; and a second voltage source for writing, onto the capacitive load, a second potential serving as the predetermined potential in such direction that the potential drops, wherein
the potential monitoring means includes: first potential monitoring means corresponding to the first voltage source; and second potential monitoring means corresponding to the second voltage source, wherein
a control signal indicative of whether to write the first potential or to write the second potential is inputted from the outside.

4. The analog output circuit as set forth in claim 1, wherein
the capacitive load is a data signal line of an active matrix type display device, and
the analog output circuit serves as an output circuit of a data signal line driving circuit.

5. The analog output circuit as set forth in claim 4, wherein
one of the voltage sources is a reference potential generation circuit for generating a reference potential of the data signal as the predetermined potential.

6. The analog output circuit as set forth in claim 1, wherein
the voltage sources include two voltage sources as: a power source line which serves as a voltage source having a lower output impedance and is extended from a direct current stabilized power supply; and a voltage dividing circuit which serves as a voltage source having a higher output impedance and divides a voltage obtained from the power source line extended from the direct current stabilized power supply.

7. The analog output circuit as set forth in claim 1, wherein
the voltage sources include two voltage sources as: a voltage follower circuit which serves as a voltage source having a lower output impedance; and a voltage dividing circuit which serves as a voltage source having a higher output impedance and divides a voltage obtained from a power source line extended from a direct current stabilized power supply.

8. The analog output circuit as set forth in claim 1, wherein
the voltage sources include two voltage sources as: a source follower circuit which serves as a voltage source having a lower output impedance; and a voltage dividing circuit which serves as a voltage source having a higher output impedance and divides a voltage obtained from a power source line extended from a direct current stabilized power supply.

9. The analog output circuit as set forth in claim 1, wherein
the voltage sources include two voltage sources as: a power source line which serves as a voltage source having a higher output impedance and is extended from a direct current stabilized power supply; and a voltage follower circuit which serves as a voltage source having a lower output impedance.

10. The analog output circuit as set forth in claim 1, wherein
the voltage sources include two voltage sources as: a power source line which serves as a voltage source having a higher output impedance and is extended from a direct current stabilized power supply; and a source follower circuit which serves as a voltage source having a lower output impedance.

11. A data signal line driving circuit, comprising the analog output circuit as set forth in claim 4.

12. A display device, comprising the data signal line driving circuit as set forth in claim 11.

13. A method in which the analog output circuit as set forth in claim 1 is used to write the predetermined potential onto the capacitive load, said method comprising a step of causing the potential monitoring means to carry out the ON/OFF control so as to cause the voltage sources to be electrically connected to the capacitive load sequentially in such an order that a voltage source having a lower output impedance is electrically connected more preferentially.

14. The analog output circuit as set forth in claim 2, wherein
the capacitive load is a data signal line of an active matrix type display device, and
the analog output circuit serves as an output circuit of a data signal line driving circuit.

15. The analog output circuit as set forth in claim 3, wherein
the capacitive load is a data signal line of an active matrix type display device, and
the analog output circuit serves as an output circuit of a data signal line driving circuit.

16. The analog output circuit as set forth in claim 14, wherein
one of the voltage sources is a reference potential generation circuit for generating a reference potential of the data signal as the predetermined potential.

17. The analog output circuit as set forth in claim 15, wherein
one of the voltage sources is a reference potential generation circuit for generating a reference potential of the data signal as the predetermined potential.

18. A data signal line driving circuit, comprising the analog output circuit as set forth in claim 5.
